(19) United States
(12) Patent Application Publication
(10) Pub. No.: US 2002/0135938 A1
(43) Pub. Date: Sep. 26, 2002

(54) Record medium cartridge and molded resin parts

(75) Inventors: Kazuo Hiraguchi, Kanagawa (JP); Wataru Iino, Kanagawa (JP); Shozo Onmori, Kanagawa (JP); Kiyoo Morita, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/078,527

(22) Filed: Feb. 21, 2002

(30) Foreign Application Priority Data
Feb. 21, 2001 (JP) 2001-044616

(51) Int. Cl. G11B 23/02; G06F 7/00; G11B 23/04

(52) U.S. Cl. 360/132; 700/218; 242/347

(57) ABSTRACT

The improved recording media cartridge is adapted to be such that an upper case and a lower case are joined by means of an engaging member fitted between fitting portions provided on the opposed inner surfaces of the respective cases. The shaped resin article is adapted to be such that individual members are shaped by multi-color molding of mutually compatible and adhesive materials and adhere to one another only in part so as to permit easy separation of the respective members. When discarded, the cartridge and the shaped resin article produce less wastes, exerting reduced impact on the environment, and prove effective in assorting dissimilar materials, thereby simplifying the disassembling operation.

### BACKGROUND OF THE INVENTION

1. Technical Field of the Invention

This invention relates to recording media cartridges such as magnetic tape cassettes and magnetic tape cartridges, as well as resin moldings that permit easy separation of parts made of different materials.

More specifically, the invention relates to recording media cartridges such as magnetic tape cassettes and magnetic tape cartridges that can be assembled and disassembled easily, that can be disposed of in reduced volumes giving less impact on the environment, and which can easily be disposed of in assortment of resin constituent materials, thus proving effective in reducing the volume of plastic scraps to thereby reduce the impact on the environment.

Further more specifically, the invention relates to resin moldings such as recording media cartridges including magnetic tape cassettes and magnetic tape cartridges that permit the residual tape check window in the cartridge enclosure (case body) to be separated easily from the latter.

2. Prior Art

Recording media cartridges used as consumer or professional video recording media or as the recording media in external storages in computers and the like are divided into two major classes, those using magnetic disks or magneto-optical disks as the recording medium (cartridges of this first class are sometimes referred to as magnetic or magneto-optical disk cartridges) and those using magnetic tape as the recording medium (cartridges of this second class are sometimes referred to as magnetic tape cartridges).

The magnetic tape cartridges of the second class include record/reproduce tape cassettes used in consumer or professional video tape recorders or video cameras, as well as magnetic tape cassettes and magnetic tape cartridges used as large-capacity recording media to back up the data in external storages in computers and the like.

The magnetic tape cartridges are available in two types, the first comprising magnetic tape wound around a single tape reel (magnetic tape cartridges of a so-called one-reel type) and the second comprising magnetic tape stretched between a pair of (two) tape reels (take-up hubs) (magnetic tape cartridges or cassettes of a so-called two-reel type). Known examples are magnetic tape cassettes of which the structural and dimensional specifications are described in JIS X6127, X6129, X6130, X6171 and X6172, as well as in ECMA-288, etc.

These recording media cartridges including magnetic or magneto-optical disk cartridges and magnetic tape cartridges or magnetic tape cassettes are used to record and reproduce information or to store data in computers and the like. In order to protect the stored valuable image and sound or other information, these recording media cartridges are so designed that magnetic or magneto-optical disks will not be damaged, or magnetic tape will not jam or will not be pulled out accidentally. To meet these needs, the various types of recording media cartridges are designed as complex structures formed of various metallic members (made of metal materials) in combination with various synthetic resin members (made of resin materials) in accordance with the performance and shapes required of the components or parts thereof.

On the pages that follow, a magnetic tape cassette of a two-reel type is described specifically as an example of the recording media cartridge. It consists of a case body that contains a pair of tape reels around which magnetic recording tape is wound and allowed to run to record and reproduce information.

FIG. 61 is an expanded perspective view showing the structure of a common magnetic tape cassette. As shown, the case body (hereunder sometimes referred to as enclosure) of the magnetic tape cassette consists of an upper case (hereunder also referred to as an upper half) 50 and a lower case (or a lower half) 52 that are joined in a face-to-face relationship and magnetic tape 56 is housed in the space between the two cases as it is stretched between a supply hub 54a and a take-up hub 54b.

A portion 56a of the magnetic tape 56 will become exposed when the magnetic tape cassette is not in service (when it is taken out of the record/reproduce apparatus and put in storage). To cover and protect this portion, a front cover (lid) 58 is provided at the front face of the upper half 50 and pivotally mounted on a pin 58a. A slider 60 is fitted to the outer underside of the lower half 52 in such a way that it can slide back and forth and this is in order to provide better seal by closing the opening in the lower part of the case body of the magnetic tape cassette.

When the magnetic tape cassette is not in service, the magnetic tape 56 between the supply hub 54a and the take-up hub 54b (the two hubs are collectively referred to as take-up hubs) may get loosened (slack) and to prevent this problem, a brake member 62 is attached to the upper half 50. The brake member 62 has two braking fingers 62a and 62b; when the magnetic tape cassette is not in service, the braking fingers 62a and 62b are normally urged against gear wheels 55a and 55b on top of the take-up hubs 54a and 54b by means of a brake spring 63, whereupon they come into engagement with the gear wheels 55a and 55b and the rotation of the take-up hubs 54a and 54b is prevented or prohibited, thereby preventing slackening of the magnetic tape 56. The brake spring 63 is in engagement with a projection 50a on the upper half 50.

A transparent window 50b is provided in the upper half 50 so that the user, looking through it, can check the residual amount of effective magnetic tape from the outside.

The lower half 52 has a rectangular bottom plate 52a which in turn has two reel shaft insertion holes 52b. By means of these reel shaft insertion holes, a pair of take-up hubs 54a and 54b around which the magnetic tape 56 is wound are supported rotatably and, in addition, when the magnetic tape cassette is loaded on the record/reproduce apparatus, it is allowed that reel shafts on the record/reproduce apparatus, which are not shown, be inserted into the take-up hubs 54a and 54b so as to drive the hubs 54a and 54b to rotate.

The bottom plate 52a also has two extensions 68 that extend forward from the right and left ends. The extensions 68 have cylindrical tape guides 68a that stand vertically from the bottom plate 52a and by which the magnetic tape 56 stretched between the take-up hubs 54a and 54b is allowed to thread through a predetermined path to become exposed at the front face of the cassette case. The space between the extensions 68 is not occupied by the bottom plate 52a of the lower half 52 but forms an opening in the cassette case through which to receive a so-called tape loading device on the deck (record/reproduce apparatus) which is to be loaded with the magnetic tape cassette.

The slider 60 has a thin flat bottom plate 60a which is to be mounted from below to come into contact with the bottom plate 52a of the lower half 52. The opening in the cassette case and the two reel shaft insertion holes 52b provided in the lower half 52 are closed to ensure dust prevention by means of the bottom plate 60a. The slider is adapted to be capable of sliding back and forth as it is guided by sidewalls 57 of the lower half 52.

When the slider 60 moves forward, the opening in the cassette case and the reel shaft insertion holes 52b are closed. When the slider 60 moves backward, the opening in the cassette case is opened and, at the same time, the reel shaft insertion holes 52b in the lower half 52 and two reel shaft insertion holes 60b in the slider 60 come into registry, making it possible to insert the reel shafts on the record/reproduce apparatus.

The bottom plate 52a of the lower half 52 also has an intermediate wall 52c arched along the magnetic tape 56 stretched between the take-up hubs 54a and 54b. A recess 52e is formed at the central joint portion of the intermediate wall 52c. A leaf spring mounting portion 52d is erected in front of the recess 52e. A slider spring 66 in the form of an obtuse equilateral triangular leaf spring is placed such that the vertex 66a of the triangle is inserted between the recess 52e and the leaf spring mounting portion 52d; as the two ends 66b of the slider spring 66 push a vertical wall-shaped rib 60c provided at the front of the slider 60, the latter is urged forward (in the direction of closing it).

While the magnetic tape cassette is not in service, the slider 60 is urged forward by means of the slider spring 66 so that the space between the extensions 68 of the lower half 52 (the aforementioned opening) and the reel shaft insertion holes 52b are closed with the bottom plate 60a of the slider 60. Although details are omitted, this closing action causes engagement pins at the tips of engagement fingers (not shown) on the bottom plate 52a of the lower half 52 to be fitted into engagement holes in the bottom plate 60a of the slider 60, thereby blocking the movement of the slider 60 (locking the slider).

When the magnetic tape cassette is in service (i.e., when it is loaded into the record/reproduce apparatus), the engagement fingers on the bottom plate 52a of the lower half 52 which are operatively associated with the loading action are pushed out of the engagement holes in the bottom plate 60a of the slider 60, which is unlocked and moves backward to open the opening between the right and left extensions 68 of the lower half 52.

As a result, the positions of the reel shaft insertion holes 52b in the lower half 52 come into registry with those of the reel shaft insertion holes 60b in the slider 60, making it possible to insert the reel shafts on the record/reproduce apparatus. At the same time, the braking fingers 62b of the aforementioned brake member 62 come out of engagement with the gear wheels 55a and 55b on top of the take-up hubs 54a and 54b, respectively, whereby information can be recorded to or reproduced from the magnetic tape 56 after loading of the magnetic tape cassette.

The magnetic tape cassette has an anti-erasure mechanism provided at a corner of its back. To make this mechanism, an anti-erasure plug insertion portion (to be precise, its lower half) that is surrounded with walls is provided at a corner of the back of the lower half 52 and an anti-erasure plug 70 is slidably inserted into this portion. The position of the anti-erasure plug 70 indicates whether information can be written to the magnetic tape 56 or not. Although not shown, an anti-erasure plug insertion portion (to be precise, its upper half) of the same shape as in the lower half 52 is provided in the corresponding area of the upper half 50 and the two portions combine to form an anti-erasure plug insertion portion 53.

FIG. 62 shows a magnetic tape cassette in an assembled state that is realized by combining the components shown in FIG. 61 such as the upper half 50, the lower half 52, the slider 60 and the lid 58. The magnetic tape cassette shown in FIG. 62 is in the state of being not in service (as it has been removed from the deck). When the magnetic tape cassette is not in service, the slider 60 is positioned forward of the cassette so that the reel shaft insertion holes 52b in the bottom 52a of the lower half 52 and the like are closed as mentioned above. In addition, the lid 58 covers the front face of the cassette to keep the cassette case sufficiently airtight to protect the magnetic tape 56 from dirt and dust. In this case, the magnetic tape 56 being directed by the tape guides 68a to run along the front face of the cassette is protected by pinching it between the lid 58 and the wall-like rib 60c on the forward positioned slider 60.

As typified by the magnetic tape cassette described above, the recording media cartridges are generally such that the upper and lower split halves are combined to make a case body which contains a recording medium such as a magnetic disk or magnetic tape as it is set in its interior. The upper and lower split halves are commonly assembled by means of screws 59.

FIG. 63 shows in section a joint of the case body as assembled by means of screws. As shown in FIG. 63, a conventional method for assembling the case body with screws is by providing two bosses 50x and 52x that abut against each other, the first boss being on the side where a screw is tightened (usually in the upper half) and the second boss being on the side where a screw is simply inserted (usually in the lower half), and by providing the boss 50x with a female thread 50y that receives a screw 59 and providing the boss 52x with an insertion hole 52y and a stepped portion 52z.

Given this structure, the screw 59 is passed into the stepped portion 52z of the boss 52x through the insertion hole 52y from the direction indicated by arrow A; then, the screw 59 is tightened into engagement with the female thread 50y in the boss 50x, whereupon the upper and lower halves are assembled with the boss 52x abutting against the boss 52x. In a current practice, a step portion is provided on one of the bosses 50x and 52x (the boss 52x in FIG. 63) so that the other boss is nested in the step portion to prevent lateral displacement.

We next describe specifically a magnetic tape cartridge of a two-reel type as another example of the recording media cartridge.

FIG. 64 shows the magnetic tape cartridge of a two-reel type, in which an upper half 50 and a lower half 52 each having a bottom plate (in a flat form) and a peripheral wall are joined in a face-to-face relationship to make a case body and magnetic tape 56 is stretched between a supply tape reel 64 and a take-up tape reel 64 as it is contained in the space defined by the two halves. A plurality of ribs are erected on the bottom plate 52a of the lower half 52 in such a way that they comply with the outer peripheries of the two tape reels and by these ribs, the tape reels 64 are prevented from being displaced in a direction parallel to their planes.

An opening is made in the bottom plate of the upper half 50 such that the user can confirm the amount by which the magnetic tape 56 has been wound onto the tape reels 64 and a transparent window (inspection window) 50b is provided to cover the opening. Provided on the inner surface (the underside in the figure) of the upper half 50 are a pair of reel urging leaf springs 28 which correspond to the respective tape reels. The reel urging leaf springs 28 are each cantilevered to the inner surface of the upper half 50 by means of a screw so that the corresponding tape reels 64 are urged toward the lower half 52.

Mounted at the front face of the upper half 50 (its left side in the figure) is a front cover (lid) that covers and protects the magnetic tape 56 when the magnetic tape cassette is not in service. As will be described later, this lid consists of three members, an outer lid 18a, an upper lid 18b and an inner lid 18c, and these members are each mounted in such a way that an opening 67 in the magnetic tape cassette can be opened or closed as required.

Two tape guides 68a are provided on two extensions 68 on opposite sides of the opening 67 made at the front end of the lower half 52 (closer to the viewer of the figure). The magnetic tape 56 being delivered from one tape reel 64 and taken up by the other tape reel 64 is guided by each tape guide 68a so that it passes by a predetermined position in the opening 67.

The lower half 52 has a tape reel locking member 37 mounted at its rear end (farther away from the viewer of the figure). The tape reel locking member 37 has a tape reel engaging arm 37a and a slider body 37b which is slidably pinched by a pair of guide ribs erected on the bottom plate 52a of the lower half 52. The tape reel locking member 37 is urged by a compressive coil spring 37d so that the tape reel engaging arm 37a engages engagement teeth 64d formed on the outer peripheries of the lower flanges 64c of the tape reels 64, thereby preventing accidental rotation of the tape reels 64. As a result, troubles with the magnetic tape 56 such as failure to be wound up tightly enough can be prevented.

While the outer lid 18a, the upper lid 18b and the inner lid 18c are mounted on the upper half 50, the outer lid 18a has a flat plate portion and side plates, with locking pins 48 projecting inside of the side plates. Part of the peripheral wall of the lower half 52 consists of sidewall portions 57, to which lid locking members 44 are mounted pivotably such that they come into engagement with the locking pins 48 on the outer lid 18a when it is in a closed state. Lid locking springs (not shown) are similarly mounted on the lower half 52 to urge the lid locking members 44 in the direction of engaging the locking pins 48.

An anti-erasure plug 70 is mounted on the lower half 52 to circumvent erroneous erasing of the data recorded to the magnetic tape 56. The anti-erasure plug 70 has a pawl projecting on one of its lateral sides (farther away from the viewer of the figure) so that when the plug is mounted in the lower half 52, the pawl will become exposed to the outside through the opening made in the peripheral wall of the upper half 50.

By manipulating the pawl from the outside, the user can move the anti-erasure plug 70 along the guide ribs erected on the bottom plate 52a of the lower half 52. The moving bottom of the plug 70 closes or opens the detection hole in the bottom plate of the lower half 52 and an apparatus such as the recorder reads the state of this detection hole to determine whether new data can be written to the magnetic tape 56.

In the magnetic tape cartridge described above, information is recorded to and reproduced from the magnetic tape 56 stretched between a pair of tape reels 64 as it is kept running in the case body. The pair of tape reels 64 are rotatably contained in the case body as the magnetic tape 56 is wound around them. Each tape reel 64 consists of a reel hub 64a to which an upper flange 64b and a lower flange 64c are welded. As in the aforementioned cases, the upper half 50 and the lower half 52 are combined and fastened together by means of five screws 59 to construct the case body as shown in FIG. 63.

The parts that make the above-described magnetic tape cartridge are formed of various materials in consideration of the characteristics required for the intended functions to be performed by those parts. For instance, the upper and lower halves, the outer lid, the upper lid and the inner lid, as well as the upper and lower flanges of the tape reels are formed by injection molding of synthetic resins. Springs such as the reel urging leaf springs and the lid locking springs, as well as screws are principally formed of metals. Other members may be formed of synthetic resins, metals or composites of metals and synthetic resins.

Still another example of the recording media cartridge is a magnetic tape cartridge of a one-reel type, in which information is recorded to and reproduced from magnetic recording tape wound around a single tape reel as it is kept running in the case body. This type of magnetic tape cartridge is specifically described below.

FIG. 65 is an exploded perspective view of the one-reel type magnetic tape cartridge. As shown, an upper half 80 and a lower half 82 are brought into a face-to-face relationship and fastened tightly with a plurality of screws 84 to make a cartridge case body and a tape reel 86 around which a magnetic tape 83 is wound is rotatably supported within the case body.

The tape reel 86 consists of an upper flange 88a and a lower flange 88b, both being disk-shaped, and a cylindrical hub 90 that is integral with the upper flange 88a and around which the magnetic tape is wound.

The upper flange 88a has a central circular opening 92 that is in registry with an inward recess 90a in the hub 90, and a disk-shaped bearing member is fitted into the center of the inward recess 90a to serve as a bearing for the rotation of the tape reel. A rotation supporting shaft member 76 that supports the rotation of the tape reel 86 is rotatably retained by the disk-shaped bearing member. The tape reel 86 is normally urged toward the lower half 82 by means of a coil spring 78 fitted on the rotation supporting shaft member 76.

The upper half 80 has a first and a second braking member (not shown) for prohibiting the rotation of the tape reel 86 when the magnetic tape cartridge is not in service and these braking members are rotatably mounted on a brake supporting shaft (not shown) provided on the inner surface of the upper half 80.

Each of the braking members has a toothed meshing portion that meshes with a wheel portion threaded on the outer peripheral edge of the upper flange 88a and they are normally urged by a torsion coil spring 78 in a direction where said meshing portion meshes with the wheel portion of the upper flange.

The upper half 80 is fitted with a door 94 that opens or closes a tape access gate through which the magnetic tape is pulled out of the cartridge case body. By means of an opening/closing spring (not shown), the door 94 is normally urged to close the tape access gate.

The bottom of the lower half 82 has a central circular opening 74. When the magnetic tape cartridge is in a use mode, the rotating shaft on the record/reproduce apparatus (deck) is inserted into the opening 74 and couples with the downwardly projecting lower end (not shown) of the hub 90 that is fitted into a corresponding hole in the lower flange 88a; as a result, the hub 90 is pushed up so that the tape reel 86 is positioned in the cartridge case body at the middle of its height.

A lateral side of the cartridge case body has an anti-erasure member (not shown) provided in a window formed by notching the upper half 80 and the lower half 82.

In the magnetic tape cartridge of a one-reel type, the case body is constructed using screws as in case shown in FIG. 63; two bosses that abut against each other are provided, the first boss being on the side where a screw is simply inserted (usually in the lower half) and the second boss being on the side where a screw is tightened (usually in the upper half), and a screw is passed from below and tightened to a female thread cut in the inner surface of the boss on the upper half.

We next describe another example of the one-reel type magnetic tape cartridge which is a variant of recording media cartridge.

In a magnetic tape cartridge as shown in FIG. 66, an upper half 150 and a lower half 152 are brought into a face-to-face relationship and fastened tightly with screws 153 to make an enclosure (hereunder also referred to simply as a case body) and a tape reel 154 around which a magnetic tape (not shown) is wound is accommodated in the case body.

The tape reel 154 consists of an upper flange 155 and a lower flange 156, both being disk-shaped, and a cylindrical hub 157 that is integral with the upper flange 155 and around which the magnetic tape is wound. The upper flange 155 has a central circular opening 159 that is in registry with an inward recess 158 in the hub 157, and a cylindrical rotation supporting shaft member 160 that serves as a bearing for the rotation of the tape reel is rotatably retained in the opening 159.

The tape reel 154 is normally urged toward the lower half 152 by means of a coil spring 161 fitted on the rotation supporting shaft member 160.

The bottom of the lower half 152 has a central circular opening 162. When the magnetic tape cartridge is in a use mode, the rotating shaft on the record/reproduce apparatus (deck) is inserted into the opening 162 and couples with the downwardly projecting lower end (not shown) of the hub 157 that is fitted into a corresponding hole in the lower flange 156; as a result, the hub 157 is pushed up so that the tape reel 154 is positioned in the cartridge case body at the middle of its height. The opening 162 has a meshing brake portion 163 formed on its inner surface; when the magnetic tape cartridge is not in service, the meshing brake portion 163 meshes with a brake portion (not shown) formed on the underside of the lower flange 152 of the tape reel 154, the rotation of which is thereby prohibited.

As in the case of the two-reel type magnetic tape cartridge, the parts of the above-described one-reel type magnetic tape cartridge are formed of synthetic resins, metals or composites of metals and synthetic resins.

Examples of the synthetic resins that are used include:

(1) POM (polyacetals) which are resin molded to make members that require sliding properties (wear resistance);

(2) PS (polystyrenes) that are supplemented with Si (silicon) in consideration of cost performance and which are resin molded; and

(3) ABS (acrylonitrile-butadiene-styrene) resins that are chosen in consideration of strength, the mixture of ABS and PC (polycarbonate), PC, and PC resins reinforced with glass fibers.

Spring members such as torsion coil springs, coil springs and opening/closing springs are made of metallic materials in accordance with the characteristics required by the parts of interest.

The case body and the tape reels around which the magnetic recording tape is to be wound are formed of appropriate resins by injection molding. Other members are formed of either synthetic resins, metals or composites of metals and synthetic resins.

With the recent concern over environmental problems, increasing attention is drawn to the possibility that the increase in various kinds of wastes including those of plastics and composite materials may cause adverse effects on the environment. A design consideration that is becoming important is reducing the impact on the environment by producing less wastes or developing products which, if discarded, will not cause air, water or soil pollution and hence do not become any problem in environmental conservation. To this end, it is necessary to design industrial products that can be integrated into a recycling system. Efforts are therefore being made to develop industrial products that are adapted to the recycling system in society at large. This is also true with magnetic tape cassettes and magnetic tape cartridges and their structures and constituent materials are often determined in consideration of compatibility with the social recycling system.

Consider here the magnetic tape cassette shown in FIG. 61. As already mentioned, the conventional method for constructing the case body of this magnetic tape cassette is by putting the upper half 50 and the lower half 52 together in a face-to-face relationship and joining them at four corners etc. by screws 59 as shown in FIG. 63. In the interior of the case body, magnetic tape formed of a different material than the case body is accommodated as it is wound around reels that are also formed of a different material than the case body.

Since the constituent members of conventional magnetic tape cassettes, magnetic tape cartridges and other recording media are made of diverse materials including synthetic resins, metals, composites of metals and synthetic resins, and still other materials, it is difficult to disassemble the recording media by constituent material. Even if used magnetic tape cassettes can be disassembled, it is difficult to assort the individual parts by constituent material and recycle them appropriately; as a result, large volumes of synthetic resins are discarded, giving a substantial impact on the environment. As another problem, rejects from the production line are difficult to disassemble and recycle. Recycling of parts that are made of expensive materials is effective for the purpose of cutting the production cost but this has been difficult to achieve with the conventional recording media.

Take, for example, the magnetic tape cartridges shown in FIGS. 64, 65 and 66. Since the case body is constructed by fastening the upper half 50 and the lower half 52 with a plurality of metallic screws 59, 84 or 153, the cumbersome unscrewing operation is needed to disassemble the case body and the time and the cost that are spent have been one of the factors that prevent effective assortment by constituent material in collecting and recycling the parts of the magnetic tape cartridges.

Also consider the magnetic tape cassette shown by an exploded perspective view in FIG. 61. The parts of this magnetic tape cassette are formed of various materials. For example, the upper half 50 and the lower half 52 of the case body, the slider 60, the magnetic tape 56, the take-up hubs 54a and 54b, the gear wheels 55a and 55b, the brake member 62, the front cover (lid) 58 and other components are formed of various materials that are used either alone or in combination as appropriate for the required characteristics. In particular, the parts or members that are formed of resins use many diverse materials that are chosen from various viewpoints including the characteristics required of the respective parts and cost effectiveness.

As already mentioned, the recent increasing concern over the environmental problems requires that resin materials to be discarded should be assorted so that they receive appropriate treatments in accordance with the resin materials of which they are made. In order to facilitate assortment of resins, industrial products made of representative resin materials including polypropylenes (PP) and polyethylenes (PE) are labelled with marks that identify the materials of which they are made, thus enabling the users to assort the individual products by constituent material.

However, as already mentioned, the magnetic tape cassettes are made of composites using various kinds of resin materials. In addition, since the individual parts are small, the material identification marks with which they are labelled are accordingly small, presenting the users with inconvenience or difficulty in assorting such parts. Some parts of the magnetic tape cassettes are too small to be labelled with appropriate material identification marks.

As already mentioned, the parts of the magnetic tape cassette shown in FIG. 61 are formed of synthetic resins. To be specific, the parts that need sliding properties (wear resistance) are formed by resin molding of POM (polyacetals); PS (polystyrenes) are supplemented with Si (silicon) and resin molded considering cost performance; ABS (acrylonitrile-butadiene-styrene) resins and the like are used if strength is an important consideration.

If video tape cassettes and the like are molded of ABS and other resins, transparent windows provided thereon through which the amount of residual tape can be checked are often molded of AS (acrylonitrile-styrene), PMMA (poly(methyl methacrylate)), etc. that are adhesive to ABS resins. This is the result of consideration of two-color molding (molding in two layers) and the adhesion between the window and the case body (cassette case) by welding.

However, in order to maintain the strength of the cassette case, the window is conventionally allowed to adhere so strongly to the case body that considerable force is needed to separate the window from the case body by the human hand. Thus, the strong adhesion between the dissimilar materials ABS and AS or PMMA makes it difficult to collect an ABS part as being separated from an AS or PMMA part. High peel strength is desirable indeed from the viewpoint of assuring the intended capability, but the configuration determined without considering the ease of product disassembly causes problems.

If the user attempts to separate the window from the case body by force, he has to break the window and then he may be hurt by the shattered pieces of window. If the window is not collected as a separate entity from the case body, a mixture of dissimilar materials will be recovered, which is hardly recycled as a regenerated material (i.e., hardly offered to material recycling), as being not of good quality and consequently hard to sell as a regenerated material. The window may be rendered easily breakable by incising (cutting slits) but then the cassette case is not sufficiently dust-proof.

Therefore, the primary objective of the present invention is to solve the aforementioned problems of the prior art and reduce the volume of wastes and, hence, the impact on the environment by providing recording media cartridges that have such a structure that the case bodies of magnetic tape cassettes can effectively be assorted for different materials by a simplified disassembling operation, specifically such a structure that the screws joining the upper case to the lower case can be eliminated, as well as resin moldings produced by an improved version of a multi-color resin molding technology which is the heart of the process for producing said recording media cartridges.

More specifically, a first object of the invention is to solve the aforementioned problems of the prior art by providing a recording media cartridge which is characterized in that although it does not use any screws to join the upper case and the lower case, the two cases can be assembled and disassembled at least as efficiently as, preferably more easily than, in the conventional case of using screws to join the upper and lower cases and also characterized in that degrees of strength and shape stability (development of neither torsion nor warpage) comparable to those obtained by using screws to join the upper and lower cases are achieved and further characterized in that the aforementioned change in the method of joining the upper and lower cases does not cause any adverse effects on the basic performance of the recording media cartridge.

More specifically, a second object of the invention is to provide a recording media cartridge which discourages or prevents accidental or perverse disassembling by recording the fact of disassembling of the recording media cartridge in an unerasable (irreparable) state once it is disassembled.

Still more specifically, a third object of the invention is to solve the aforementioned problems of the prior art by providing a recording media cartridge which is characterized as follows: an upper case and a lower case can be conveniently joined without using any metallic members such as screws and still the joined cases maintain sufficient integrity to make a rugged case body; upon disassembling of the case body, the upper case can be easily separated from the lower case by simply canceling the joint between the two cases; different resin materials can be easily assorted for collection and recycling, thus effectively reducing the volume of resin wastes.

More specifically, a fourth object of the invention is to solve the aforementioned problems of the prior art by providing a recording media cartridge that uses less synthetic resins, that permits easy separation of synthetic resins from metals, which can be discarded in a smaller number of parts without exerting undue impact on the environment after disassembling, which in the manufacturing process permits the recycling of disassembled parts on account of the ease of disassembling, and which is composed of a smaller number of parts to be assembled easily.

Yet more specifically, a fifth object of the invention is to solve the aforementioned problems of the prior art by providing a recording media cartridge that permits easy assortment of the constituent resin materials of the parts or members of the cartridge and which hence is effective not only in promoting assorted discarding of the resins but also in reducing the volume of resin wastes.

More specifically, a sixth object of the invention is to solve the aforementioned problems of the prior art by providing a shaped resin article that permits the individual constituent members to be easily separated without impairing its capabilities.

The present invention also provides an improved version of a multi-color resin molding technology which is the heart of the process for producing recording media cartridges.

Still other objects of the invention will become apparent by reading the following description.

### SUMMARY OF THE INVENTION

With a view to attaining the stated principal objective of the invention as well as the above-mentioned first to sixth specific objects, the present inventors conducted intensive studies on how to reduce the volume and, hence, the environmental impact of wastes from magnetic tape cassettes and other recording media cartridges having the above-described conventional structures, and on the multi-color resin molding technology which is the heart of the process for producing such recording media cartridges. As a result, it has been found that various approaches can be taken to deal with these problems. Further, the present inventors have found that one approach that can be proposed is designing a structure for the case body of a magnetic tape cassette that is effective for assorting different materials and which allows the disassembling operation to be performed in simplified steps, specifically by eliminating the screws conventionally used to join the upper and lower cases. The inventors have also found that the following points should be taken into consideration in designing such a structure.

The first point to be considered is that the upper and lower cases should preferably be assembled and disassembled at least as efficiently as in the conventional case of using screws to join the two cases. It is also necessary that degrees of strength and shape stability (development of neither torsion nor warpage) comparable to those obtained by using screws to join the upper and lower cases be achieved. Most importantly, the aforementioned change in the method of joining the upper and lower cases should not cause any adverse effects on the basic performance of the recording media cartridge.

On the basis of the aforementioned findings, the present inventors have accomplished the present invention which is described below in detail.

The stated principal objective of the invention and its first object can be attained by a first aspect of the invention according to which there is provided a recording media cartridge that has a recording medium accommodated in a case body formed by joining an upper case and a lower case in a face-to-face relationship, wherein said upper case and said lower case are joined by means of an engaging member fitted between fitting portions provided on the opposed inner surfaces of both cases, respectively.

Said engaging member is preferably a spring pin.

In another preferred embodiment, said fitting portions provided on said upper case and said lower case are either a pair of fitting holes provided within bosses erected on the opposed inner surfaces of said upper case and said lower case, respectively, or a fitting hole provided on one of the opposed inner surfaces of said upper case and said lower case and a projection provided on the other inner surface and said engaging member is fitted between said pair of fitting holes provided on the opposed surfaces of said upper case and said lower case or between the fitting hole provided on said one inner surface and the projection provided on said other inner surface.

In yet another preferred embodiment, at least one of said fitting holes in pair or either the fitting hole provided on said one inner surface or the projection provided on said other inner surface or both said fitting hole and said projection are provided with a disengagement hole into which a disengaging tool is inserted in order to cancel the state of fitting.

As described above, in the first aspect of the invention, at least one of engaging member fitting holes provided on said opposed surfaces of the upper and lower cases may be a through-hole. The state of fitting realized in this case is such that the aforementioned engaging member is inserted into the through-hole until it reaches the other non-through-hole (blind hole).

If desired, at least one of said fitting holes may be replaced by a projection over which said engaging member is to be fitted. The projection has preferably a disengaging pin insertion hole in its interior. The state of fitting realized in this case is such that one end of the aforementioned engaging member is inserted into the aforementioned fitting hole whereas the other end is fitted over said projection.

The stated principal objective of the invention and its first object can also be attained by a second aspect of the invention according to which there is provided a recording media cartridge that has a recording medium accommodated in a case body formed by joining an upper case and a lower case in a face-to-face relationship, wherein said upper case and said lower case are joined by means of an engaging member fitted between recesses provided in the outer surfaces of both cases, respectively.

Said engaging member is preferably a U-shaped engaging member having in both its end portions functional engaging portions that fit into said recesses of said upper case and said lower case to engage therewith.

Said engaging member is preferably such that the functional engaging portions, that fit into said recesses of said upper case and said lower case to engage therewith, are provided on an upper case side and a lower case side, respectively, and is in the form of hollow triangular prism (right-angled triangular prism) for (suitable for) fitting on a corner portion of said case body.

In another preferred embodiment, said engaging member is such that its functional engaging portions, that fit into said recesses of said upper case and said lower case to engage therewith, are processed on the engaging surfaces facing said case body (i.e., facing the recording media cartridge) to have a greater frictional resistance with respect to the contact surfaces of said upper case and said lower case; alternatively, it is preferred that an engaging structure as a combination of a groove and a ridge is provided.

The aforementioned engaging member is preferably provided with a disengaging portion (portion to be engaged by a disengaging tool) applied to cancel the state of fitting. The disengaging portion is preferably formed as a groove or a hole.

The stated principal objective of the invention and its first object can also be attained by a third aspect of the invention according to which there is provided a recording media cartridge that has a recording medium accommodated in a case body formed by joining an upper case and a lower case in a face-to-face relationship, wherein said upper case and said lower case are joined by means of an engaging member fitted between the sidewall surfaces of both cases.

Said engaging member is preferably an engaging plate or a spring pin.

Said engaging member is preferably processed to have a greater frictional resistance with respect to the contact surfaces of said upper case and said lower case.

Preferably, a disengagement hole into which a disengaging tool is inserted to cancel the state of fitting is provided in the position where said engaging member is fitted.

If the surfaces where said upper case and said lower case engage each other are not flush but are offset, a dust-proof member that cancels the offset is preferably provided in the areas other than the position where said engaging plate or said spring pin is fitted.

If desired, a portion of said upper case or said lower case may be designed to have a sufficient wall thickness to absorb said offset. In this case, the aforementioned engaging member is fitted between the upper and lower cases in the interior of the thick-walled portion; as a result, the engaging member is concealed from the outside, giving a neat exterior appearance.

The stated principal objective of the invention and its third object can also be attained by a fourth aspect of the invention according to which there is provided a recording media cartridge that has a medium holder for holding a recording medium accommodated in a case body formed by joining an upper case and a lower case in a face-to-face relationship, wherein an engaging member, which has an upper engaging end at the upper end and a lower engaging end on a lateral side of the lower end, is provided between said upper case and said lower case along the inner surface of a sidewall of said case body, said upper engaging end being brought into engagement with an engaging portion provided on the top plate of said upper case and said lower engaging end being brought into engagement with an engaging portion provided on a sidewall of said lower case, whereby said upper case and said lower case are joined to make said case body.

Preferably, said engaging member does not interfere with the rotation of said medium holder and is located in opposed positions in at least two areas of said upper case and said lower case.

The stated principal objective of the invention and its first and second objects can also be attained by a fifth aspect of the invention according to which there is provided a recording media cartridge that has a recording medium accommodated in a case body formed by joining an upper case and a lower case in a face-to-face relationship, wherein said upper case and said lower case are adapted to be such that they are joined by means of an engaging hole that is provided in at least one of said cases and into which an engaging member is fitted from the other case and wherein said engaging hole is provided with a member that covers a disengaging portion but which can be broken to initiate a disengaging action.

Preferably, a coupling strut is used as a mechanism which establishes engagement with said engaging hole, that is provided on the case opposite the one having said engaging hole and which has a split bulging portion at its tip.

In another preferred embodiment, a spring pin is used as a mechanism which establishes engagement with said engaging hole, that is fitted between engaging holes provided in said upper case and said lower case.

In yet another preferred embodiment, a plate-shaped engaging member is used as a mechanism which establishes engagement with said engaging hole, that is inserted into a slit-like portion provided between said upper case and said lower case.

The recording media cartridge according to the fifth aspect of the invention has the advantage that if the operator disassembles it for some reason, the fact is recorded in an irreparable state, contributing a lot to the effort to identify the cause of a future trouble.

The stated principal objective of the invention and its fourth object can also be attained by a sixth aspect of the invention according to which there is provided a recording media cartridge that has a recording medium accommodated in a case body formed by joining an upper case and a lower case in a face-to-face relationship, wherein said lower case has a lower engaging portion formed on an upper edge side thereof and said upper case has an upper engaging portion provided on a lower edge side thereof correspondingly to the lower engaging portion and said lower engaging portion is brought into engagement with said upper engaging portion, whereby said lower case is joined integrally with said upper case to make the case body.

Said lower engaging portion and said upper engaging portion are preferably provided in at least four areas of said upper edge side of said lower case and said lower edge side of said upper case, typically in the positions that correspond to at least four corners of the case body constructed by joining the lower case integrally with the upper case. Factors such as the areas where said lower and upper engaging portions are formed and the mode of bringing them into mutual engagement are selected as appropriate for the configuration of the recording media cartridge. Using a biodegradable synthetic resin as the constituent material of the cartridge is recommended since no additional impact will be exerted on the environment even if disassembled parts are discarded.

The following structures (1) to (4) are four examples of the structure of the recording media cartridge having the above-described lower and upper engaging portions.

(1) A structure in which an engaging toothed portion is formed on a periphery of either a lower edge side of the upper case or an upper edge side of the lower case and an engaging pawl that meshes with the engaging teeth is formed on a periphery of either an upper edge side of the lower case or a lower edge side of the upper case, with the engaging pawl being allowed to mesh with said engaging toothed portion.

(2) A structure in which an elastically deformable coupling member having an engaging pawl at its tip is provided on either the upper case or the lower case and a fitting hole into which said coupling member is to be inserted and which has an engaging portion that engages said engaging pawl is provided in either the lower case or the upper case in correspondence with said coupling member, said coupling member being deformed elastically so that said engaging pawl is inserted into said fitting hole to come into engagement with the engaging portion.

(3) A structure in which a coupling strut having a split portion at its tip is provided on either the upper case or the lower case and a mounting hole into which said coupling strut is to be inserted to come into a fitting engagement as said split portion deforms elastically and in which a projection is provided on a sidewall of either the upper case or the lower case and a recess corresponding to the projection is provided on a sidewall of either the lower case or the upper case, said coupling strut being inserted into said mounting hole to come into fitting engagement while at the same time said projection is fitted into said recess.

(4) A structure in which a coupling strut having a split portion at its tip and a projection on its outer periphery is provided on either the upper case or the lower case and a mounting hole into which said coupling strut is to be inserted to come into a fitting engagement as said split portion deforms elastically and which has a recess in its inner periphery that corresponds to said projection, said coupling strut being inserted into said mounting hole to come into fitting engagement while at the same time said projection is fitted into said recess.

The stated principal objective of the invention and its first object can also be attained by providing a recording media cartridge that has a magnetic tape on reels accommodated in a case body formed by joining an upper case and a lower case in a face-to-face relationship with the aid of a pawl and an engaging member that corresponds to the pawl, wherein said pawl and said engaging member that corresponds to said pawl are provided on said upper case and said lower case at least in a position near a tape guide portion and in positions including said position that are near the four corners of said case body.

Preferably, said recording media cartridge is of a two-reel type and has said pawl and said engaging member that corresponds to said pawl, that are to be provided near said tape guide portion, in two positions near said tape guide portion.

More preferably, said pawl and said engaging member that corresponds to said pawl are built into said tape guide portion.

In another preferred embodiment, said recording media cartridge is of a one-reel type and has said pawl and said engaging member that corresponds to said pawl, that are to be provided near the tape guide portion, at least in one position near said tape guide portion and in a position generally symmetric with said position as well.

In this aspect of the invention, it is preferred that a release hole (disengagement hole) is provided as necessary so that manipulation can be made through it in order to cancel the engagement established between the upper case and the lower case by means of said pawl and said engaging member that corresponds to said pawl. Preferably, the disengagement hole is adapted to have a dust-proof structure which prevents the entrance of dirt and dust into the recording media cartridge.

In this aspect of the invention, it is also preferred that a plurality of engaging mechanisms each composed of said pawl and said engaging member that corresponds to said pawl are partially provided in the neighborhood of a sliding member in said recording media cartridge (e.g., a brake member and a lid locking member or an anti-erasure plug in a recording media cartridge or cassette of a two-reel type). This contributes to improving stability in the action of these sliding members.

Practically feasible examples of the engaging mechanism which consists of the pawl and the engaging member that corresponds to it include but are not limited to a type that is composed of one pawl and one engaging member that corresponds to it (for convenience' sake, this type of engaging mechanism is hereunder referred to as a snap mechanism) and a type that is composed of a series of pawls and an engaging member having one or more engaging portions that correspond to the pawls (this type of engaging mechanism is hereunder referred to as a ratchet mechanism).

Whichever type is adopted, the pawl and the engaging member that corresponds to it are molded of a resin as is the case body (actually composed of an upper and a lower cases) of the recording media cartridge. A suitable mold is preferably constructed using a core in the form of a pivotally supported ejector pin which is the design disclosed in commonly assigned JP 2000-238047 A.

The stated principal objective of the invention and its first object can also be attained by an eighth aspect of the invention according to which there is provided a recording media cartridge that has a recording medium accommodated in a case body formed by joining an upper case and a lower case in a face-to-face relationship, wherein said upper case and said lower case are adapted to be joined by means of an engaging member provided on either said upper case or said lower case and an engaging portion having a cutout provided on either said lower case or said upper case.

Said cutout provided on either said lower case or said upper case is preferably in a sidewall portion of either said lower case or said upper case which is to be contacted by the tip portion of said engaging member provided on either said upper case or said lower case. It is also preferable that a second additional cutout is provided in the bottom of either said lower case or said upper case as an extension from the cutout provided in said sidewall portion. The depth of the second cutout (as measured from a lateral side) preferably reaches the neighborhood of the central position (as measured from a lateral side) of said engaging member in engagement with the engaging portion.

The tip of said engaging member is preferably adapted to have an appropriately tapered or curved outer surface. In the eighth aspect of the invention, the positions where the aforementioned engaging member is provided (which are also the positions of the engaging portion that receives it) are preferably in areas of the recording media cartridge that are near the four corners.

The reason is as follows. Areas of the recording media cartridge that are near the four corners are in most cases used as reference planes for the cartridge. Even if deformations due, for example, to creeping of the aforementioned engaging member occur during prolonged use, the offset of reference planes will be held to comparatively small levels if the amounts of such deformations are generally uniform and no warpage will develop in the cartridge, reducing the likelihood for the occurrence of problems such as failure in loading onto or unloading from the drive.

The aforementioned engaging member is preferably made of a material selected from materials that are resistant to deformations caused by creeping and other stresses. Among the materials known today, PC (polycarbonates), PPS [poly(phenylene sulfides)] and POM (polyacetals) may be named as suitable examples.

The stated principal objective of the invention and its third object can be attained by a ninth aspect of the invention according to which there is provided a recording media cartridge that has a recording medium accommodated in a case body formed by joining an upper case and a lower case in a face-to-face relationship, wherein a fitting groove portion is formed between a guide arm portion, which projects from one sidewall of said upper case to extend parallel to another sidewall of said upper case crossing said one sidewall at right angles, and said another sidewall, said recording media cartridge having a linear guide ridge formed on a lateral surface of said guide arm portion which faces said fitting groove portion, a linear introduction groove cut in the inner surface of said one sidewall of said upper case within the area of said fitting groove portion to extend from the lower case side toward the upper case side, and a disengagement groove cut to extend from said linear introduction groove toward said another sidewall of said upper case via a continuous upwardly arched engagement groove, said recording media cartridge also having a sliding member that is slidably fitted in said fitting groove portion and a fit insertion member that is erected on the bottom of said lower case and which is slidably fit inserted into said fitting groove portion, said sliding member having a slide groove into which said linear guide ridge is fitted, an engaging portion provided on the inner bottom surface of said slide groove that engages an engaging pawl end provided on said linear guide ridge at its end closer to said lower case, and a meshing pawl portion that meshes with a meshing recess provided in said fit insertion member, said recording media cartridge having a guide pin that fits loosely into a linear loose insertion groove cut through the body of said sliding member, with the head at one end of said guide pin being slidably fitted in said linear introduction groove, said linear engagement groove and said disengagement groove and the head at the other end projecting from a surface of the sliding member, and a disengagement hole that extends through said another sidewall of said upper case to communicate with an end of said disengagement groove.

Said upper and lower cases have preferably the joint structure as described above on their sidewalls in at least two opposed areas of the case body. In other words, in the ninth aspect of the invention, the upper case and the lower case are preferably joined by said joint structure in at least two areas. For example, said joint structure may be provided on the sidewalls in at least two opposed areas of the case body, whereby the upper case and the lower case are joined to make the case body. If necessary, the joint structure may be provided in four areas near the four corners of the case body or even in five or more areas.

The stated principal objective of the invention and its fifth object can be attained by a tenth aspect of the invention according to which there is provided a recording media cartridge that has a recording medium accommodated in a case body formed by joining an upper case and a lower case in a face-to-face relationship, wherein the constituent parts of said recording media cartridge are colored differently according to the resin materials of which they are made so that the constituent materials of the respective parts can be differentiated and assorted as said recording media cartridge is disassembled.

The stated principal objective of the invention and its sixth object can be attained by an eleventh aspect of the invention according to which there is provided a shaped resin article adapted to be easily separable into members of different constituent materials, wherein the respective members are shaped by multi-color molding of mutually compatible and adhesive materials and are allowed to adhere to one another only in part.

It should be noted that the multi-color molding technology under consideration is not only applicable to the purpose of molding parts of recording media cartridges; it is widely applicable to the molding of plastic members that can be disassembled easily.

It should also be noted that while recording media cartridges include those using magnetic disks or magneto-optical disks (e.g. magnetic disk cartridges) and those using magnetic tape (i.e., magnetic tape cartridges and magnetic tape cassettes), the concept of the invention can be applied to all kinds of recording media as long as the recording media cartridge is constructed by combining the upper and lower cases.

### BRIEF DESCRIPTION OF THE DRAWINGS

FIG. 1 is a partial enlarged sectional view showing how an upper half is combined with a lower half in a magnetic tape cassette according to an embodiment of the invention;

FIGS. 2A, 2B and 2C are perspective views showing examples of a detailed structure for a spring pin which is an essential part of the embodiment shown in FIG. 1;

FIG. 3 is a partial enlarged sectional view showing how an upper half is combined with a lower half in a magnetic tape cassette according to another embodiment of the invention;

FIG. 4 is a partial enlarged sectional view showing how an upper half is combined with a lower half in a magnetic tape cassette according to a still another embodiment of the invention;

FIG. 5 is a partial enlarged perspective view showing how an upper half is combined with a lower half in a magnetic tape cassette according to yet another embodiment of the invention;

FIG. 6 is section of a fitting groove portion which is an essential part of the embodiment shown in FIG. 5;

FIG. 7 is a partial enlarged perspective view of a disengagement groove in the engaging member according to the embodiment shown in FIG. 5;

FIG. 8 is a partial enlarged sectional view showing how an upper half is combined with a lower half in a magnetic tape cassette according to a further embodiment of the invention;

FIG. 9 is a partial enlarged sectional view showing how an upper half is combined with a lower half in a magnetic tape cassette according to another embodiment of the invention;

FIG. 10 is a partial enlarged perspective view showing how an upper half is combined with a lower half in a magnetic tape cassette according to a still another embodiment of the invention;

FIG. 11 is a partial enlarged sectional view showing how an upper half is combined with a lower half in a magnetic tape cassette according to yet another embodiment of the invention;

FIGS. 12A and 12B are perspective views showing detailed structures for an engaging plate which is an essential part of the embodiment shown in FIG. 11;

FIGS. 13A and 13B are enlarged perspective views of the area where the engaging plate is inserted in the magnetic tape cassette shown in FIG. 11;

FIG. 14 is a partial enlarged sectional view showing how an upper half is combined with a lower half in a magnetic tape cassette according to another embodiment of the invention;

FIGS. 15A, 15B, 15C and 15D are partial enlarged sectional views showing how an upper half is combined with a lower half in a magnetic tape cassette according to an embodiment of the invention;

FIG. 16 is a perspective view showing the case body of the magnetic tape cassette as assembled according to the embodiment;

FIG. 17 is a partial enlarged sectional view showing how an upper half is combined with a lower half in a magnetic tape cassette according to another embodiment of the invention;

FIG. 18 is an enlarged sectional view showing details of the engaging portion shown in FIG. 17;

FIG. 19 is an enlarged perspective view showing details of a split bulging portion in the engaging portion shown in FIGS. 17 and 18;

FIG. 20 is a plan view showing details of a cover member in the engaging portion according to the embodiment shown in FIGS. 17 and 18;

FIG. 21 is a sectional view showing a detailed structure for a modification of the engaging portion according to the embodiment shown in FIGS. 17 and 18;

FIG. 22 is a partial enlarged sectional view showing how an upper half is combined with a lower half in a magnetic tape cassette according to another embodiment of the invention;

FIG. 23 is an enlarged sectional view showing details of the engaging portion shown in FIG. 22;

FIG. 24 is a partial sectional view showing how an upper half is combined with a lower half in a magnetic tape cassette according to yet another embodiment of the invention;

FIG. 25 is an enlarged sectional view showing details of the engaging portion shown in FIG. 24;

FIG. 26A is a perspective view of an upper half, as seen from above, for a magnetic tape cassette according to a still another embodiment of the invention and

FIG. 26B is a partial enlarged view of the upper half of FIG. 26A;

FIG. 27A is a perspective view of an upper half, as seen from below, for the magnetic tape cassette according to said still another embodiment of the invention and

FIG. 27B is a partial enlarged view of the upper half of FIG. 27A;

FIG. 28A is a perspective view of a lower half, as seen from above, for the magnetic tape cassette according to said still another embodiment of the invention and

FIG. 28B is a partial enlarged view of the lower half of FIG. 28A;

FIG. 29A is a perspective view of a lower half, as seen from below, for the magnetic tape cassette according to said still another embodiment of the invention and

FIG. 29B is a partial enlarged view of the lower half of FIG. 29A;

FIG. 30 is a perspective view showing how the upper half and the lower half for the magnetic tape cassette according to said still another embodiment of the invention are joined;

FIG. 31 is a partial enlarged sectional view illustrating how the upper and lower halves of the magnetic tape cassette shown in FIG. 30 are joined and how to disassemble them;

FIG. 32A is a sectional view illustrating the constructions of the engaging pawl portion of the upper half and the engaging toothed portion of the lower half of the magnetic tape cassette according to the embodiment and

FIG. 32B is a sectional view illustrating the structure of the engaging teeth in the saw-toothed engaging portion of the engaging toothed portion of the lower half;

FIG. 33A is a perspective view of the upper half of a magnetic tape cassette according to still another embodiment of the invention and

FIG. 33B is a perspective view of the lower half;

FIG. 34 is an enlarged sectional view showing a fitting portion in the magnetic tape cassette built by combining the upper and lower halves shown in FIGS. 33A and 33B;

FIG. 35 is a perspective view, with part taken away, of a portion of a magnetic tape cassette according to yet another embodiment of the invention;

FIG. 36 is a perspective view, partially in section, which shows enlarged the fitting portion of the magnetic tape cassette shown in FIG. 35;

FIG. 37 illustrates in conceptual form how an upper half is fitted to a lower half in a magnetic tape cassette according to a further embodiment of the invention;

FIG. 38A is a section of a fitting portion in the magnetic tape cassette shown in FIG. 37 and

FIG. 38B is an enlarged view of the fitting portion of FIG. 38A;

FIG. 39 is a plan view of a lower half for a magnetic tape cassette according to another embodiment of the invention;

FIG. 40 is section of the lower half of FIG. 39 taken along the broken line II-II, the lower half being assembled in registry with an upper half;

FIGS. 41A and 41B are sectional views each showing an engaging mechanism in a magnetic tape cassette according to other embodiment of the invention;

FIGS. 42A and 42B are plan views (bottom views) each showing a modification of the examples shown in FIGS. 40, 41A and 41B;

FIG. 43 is a sectional view showing an engaging mechanism in a magnetic tape cassette according to yet another embodiment of the invention;

FIG. 44 is a plan view of a lower half for a magnetic tape cassette according to a further embodiment of the invention;

FIG. 45 is a partial enlarged sectional view showing how an upper half is combined with a lower half in a magnetic tape cassette according to a still further embodiment of the invention;

FIGS. 46A, 46B and 46C are sectional views showing details of three examples of an engaging plate which is an essential part of the embodiment shown in FIG. 45;

FIG. 47 is a partial enlarged perspective view showing how an upper half is joined with a lower half in a magnetic tape cassette according to another embodiment of the invention;

FIG. 48 is a partial enlarged perspective view showing how the upper half is joined with the lower half in the magnetic tape cassette according to said another embodiment of the invention;

FIG. 49 is a partial enlarged perspective view showing details of an engaging portion in the magnetic tape cassette according to said another embodiment of the invention;

FIG. 50 is an enlarged perspective view showing details of the upper half side of the engaging portion in the magnetic tape cassette according to said another embodiment of the invention;

FIG. 51 is an enlarged perspective view showing details of the lower half side of the engaging portion in the magnetic tape cassette according to said another embodiment of the invention;

FIG. 52A is a perspective view showing an example of a sliding member in the engaging portion of the magnetic tape cassette according to said another embodiment of the invention,

FIG. 52B is a perspective view showing the combination of the sliding member with a guide pin, and

FIG. 52C is a perspective view showing a modification of the sliding member;

FIG. 53 is a diagram illustrating the action of the guide pin in the engaging portion of the magnetic tape cassette according to said another embodiment of the invention;

FIG. 54 is a plan view of a lower half for a magnetic tape cassette according to a further embodiment of the invention;

FIG. 55 is a perspective view showing a magnetic tape cassette according to a still further embodiment of the invention;

FIG. 56 is a plan view showing the back side of an upper half for the magnetic tape cassette shown in FIG. 55;

FIG. 57 is an enlarged perspective view of the magnetic tape cassette of FIG. 55 as taken through the upper half and the window;

FIG. 58 is section of the upper half and the window taken along the line IV-IV in FIG. 57;

FIGS. 59A and 59B are diagrammatic sectional views showing an exemplary mold that can be used to shape the magnetic tape cassette according to said still further embodiment of the invention, and FIG. 59C is a perspective view showing a movable core in the mold;

FIG. 60 is a sectional view of a window and an upper half according to yet another embodiment of the invention;

FIG. 61 is an exploded perspective view showing the structure of a conventional common magnetic tape cassette of a two-reel type;

FIG. 62 is a perspective view showing the external appearance of the magnetic tape cassette of FIG. 61 in an as-assembled state;

FIG. 63 is a partial sectional view of a screw-based joint in the case body of a conventional common magnetic tape cassette;

FIG. 64 is an exploded perspective view showing the structure of a conventional common magnetic tape cartridge of a two-reel type that differs from the cassette shown in FIG. 61;

FIG. 65 is an exploded perspective view showing the structure of a conventional common magnetic tape cartridge of a one-reel type; and

FIG. 66 is an exploded perspective view showing the structure of a conventional common magnetic tape cartridge of a one-reel type that differs from what is shown in FIG. 65.

### DETAILED DESCRIPTION OF THE INVENTION

We now describe in detail the magnetic tape cartridges and resin moldings of the invention with reference to the preferred embodiments shown in accompanying drawings.

The following description is mainly concerned with the case of applying the present invention to magnetic tape cartridges (magnetic tape cassettes) of a two-reel type. Needless to say, the invention is equally applicable to the aforementioned various types of recording media cartridges.

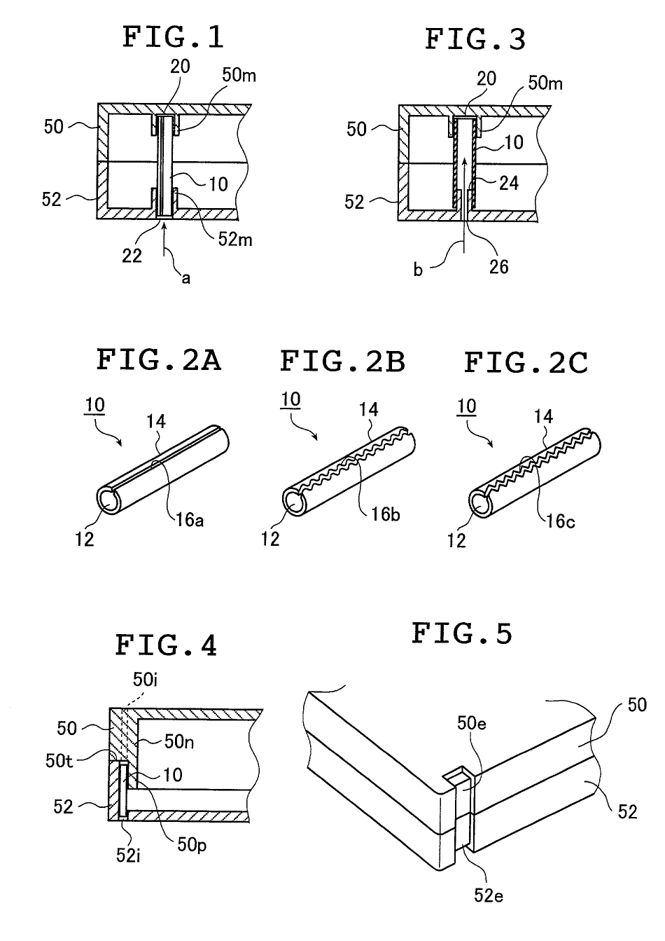

First, we refer to FIGS. 1-4 and describe a recording media cartridge according to the first aspect of the invention.

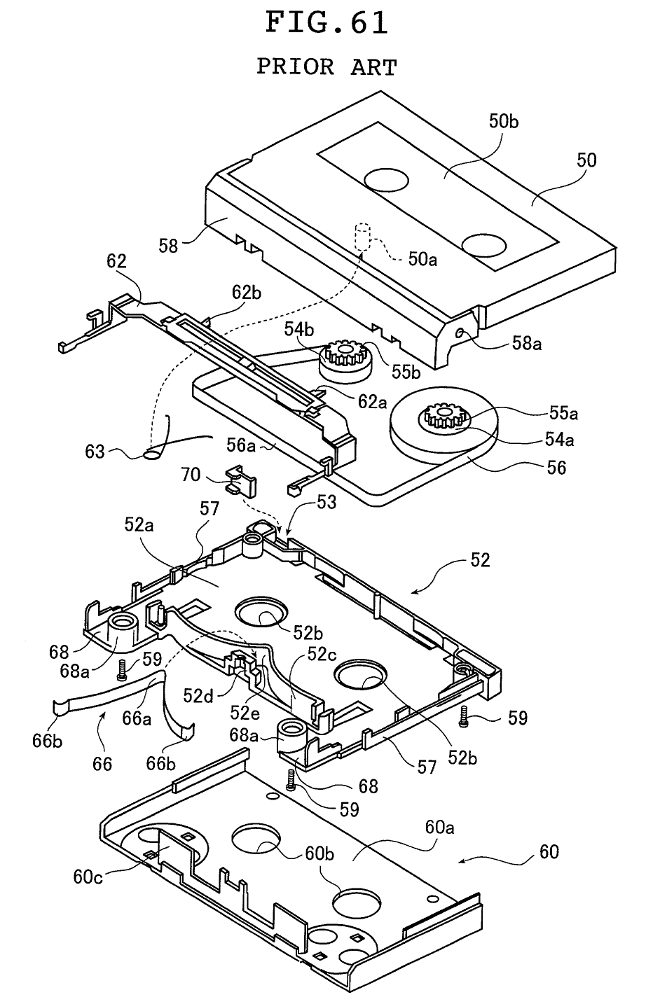

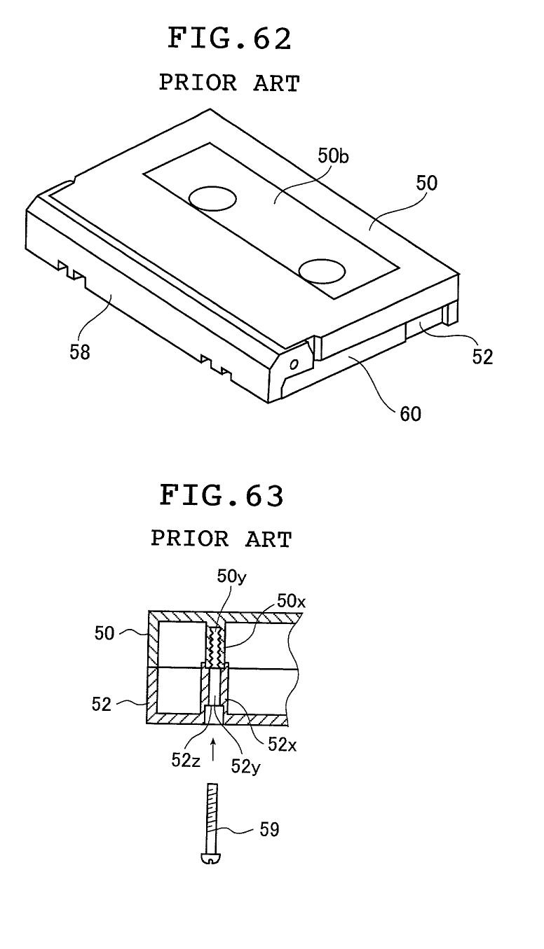

FIG. 1 is a partial enlarged sectional view showing how an upper half is combined with a lower half to make a magnetic tape cassette according to an embodiment of the first aspect of the invention. The general construction of the magnetic tape cassette has already been described with reference to FIGS. 61 and 62 and, in the following, only the essential points are described.

In FIG. 1, numerals 50 and 52 refer to the upper half and the lower half, respectively, of the aforementioned magnetic tape cassette, which are shown to be joined together with a spring pin 10 fitted in. Detailed structures for the spring pin 10 used to join the two halves are shown in FIGS. 2A-2C.

As is clear from FIG. 1, in the upper and lower halves of the magnetic tape cassette according to the embodiment under consideration, the tall bosses used in the conventional screw-based assemblage shown in FIG. 63 are replaced by a boss 50m and a boss 52m; the boss 50m is formed on the upper half 50 to form a blind fitting hole 20 having the necessary depth to support the spring pin 10, and the boss 52m is formed on the lower half 2 to form a through-hole 22 also having the necessary depth to support the spring pin 10.

As shown in FIGS. 2A-2C, the spring pin 10 is an element in the form of a hollow pipe, with a slit 16 formed in the lateral side. The slit 16 may take various shapes, including a straight slit 16a shown in FIG. 2A, a wavy slit 16b in FIG. 2B, and a slit 16c in FIG. 2C, which is shaped like a triangular wave.

When the spring pin 10 is fitted into a fitting hole having an inside diameter slightly smaller than its outside diameter or, conversely, fitted over a projection having a slightly larger outside diameter than its inside diameter (details of both cases will be given later), a stress will develop from the difference in diameter; the slit 16 is provided to utilize the stress to keep the spring pin 10 in position as it is fitted into the hole (or fitted over the projection).

Another effective way to keep the spring pin 10 in position as it is fitted into the hole (or fitted over the projection) is by roughening the inner surface 12 of the spring pin 10 (if it is to be fitted over a projection 24 provided on the lower half of the magnetic tape cassette) or its outer surface 14 (if it is to be fitted into a fitting hole 20 provided in the upper half of the cassette) in order to increase the friction with the surface of the projection 24 or the inner surface of the hole 20.

Specific examples of the surface roughening technique include providing steps along the length of the spring pin 10, knurling such as double-cutting, and matting. These are not the sole examples that can be employed and combining them with the conferring of tackiness is also effective.

Turning back to FIG. 1, we will continue the explanation.

In the embodiment under consideration, the spring pin 10 is inserted into the lower half 52 through the hole 22 in its underside as indicated by an arrow a and fitted into the fitting hole (blind hole) 20 made in the upper half 50. Preferably, the areas where the spring pin 10 is inserted into the through-hole are provided at least in the neighborhood of the four corners of the magnetic tape cassette.

Given this design, the lower half 52 and the upper half 50 are firmly joined together by the force of friction between each half and the spring 10. For assembling purposes, it is preferred to set the lower half 52 on a platen or the like so that an exact degree of levelness is assured.

If a need arises to disassemble the magnetic tape cassette as in the case of discarding it, a pin-shaped disassembling tool is applied to the lower end of the spring pin 10 exposed within the through-hole 22 and the tool is pushed up in FIG. 1, whereby the cassette can be easily disassembled.

FIG. 3 is a partial enlarged sectional view showing how an upper half is combined with a lower half to make a magnetic tape cassette according to another embodiment of the first aspect of the invention. In the magnetic tape cassette according to this embodiment, the spring pin 10 is mounted in the upper and lower halves in a different way than in the first embodiment.

To be more specific, in the magnetic tape cassette according to the second embodiment, the spring pin 10 is mounted on the upper half 50 of the cassette by fitting it into the fitting hole 20 in the boss 50m on the upper half 50 as in the first embodiment; on the other hand, the spring pin 10 is mounted on the lower half 52 by fitting it over a boss 24 on the lower half 52.

An advantage of this mounting system as adopted by the magnetic tape cassette according to the second embodiment is that the spring pin 10 receives a force at an end that squeezes it whereas it receives a force at the other end that expands it, thus the force of engagement with the upper and lower halves is increased.

If a need arises to disassemble the magnetic tape cassette having the above-described structure, a pin-shaped disassembling tool is inserted into a disengagement hole 26 in the boss 24 on the lower half 52 as indicated by an arrow b in FIG. 3 and the tool is pushed up, whereby the cassette can be easily disassembled.

FIG. 4 is a partial enlarged sectional view showing how an upper half is combined with a lower half to make a magnetic tape cassette according to a still another embodiment of the first aspect of the invention. In the magnetic tape cassette according to this embodiment, the latitude in the selection for the position at which the spring pin 10 is inserted between the upper and lower halves is increased and more of the spring pins 10 are inserted to ensure a firm joint between the upper and lower halves; to this end, the wall thickness of the engaging portion of the upper half 50 is increased.

In this embodiment, the spring pin 10 is inserted from below. If desired, the orientation in engagement may be reversed by increasing the wall thickness of the engaging portion of the lower half 52 and inserting the spring pin 10 from above.

In the embodiment under consideration, part of the edge of the upper half 50 (which is used to join the upper and lower halves) forms a thick-walled portion 50n and the spring pin 10 is inserted between a part (inner part) 50p of the thick-walled portion 50n and the edge portion of the lower half 52, whereby the upper half is joined to the lower half. To be more specific, in the embodiment shown in FIG. 4, an appropriate number of areas (through-boles) 52i into which the spring pin 10 is inserted are provided in the underside of the lower half 52 along the edge portions of the two halves and disengagement holes 50i are provided in the thick-walled portion 50n of the upper half 50.

In the embodiment under consideration, an appropriate number of spring pins 10 are inserted from the areas (through-holes) 52i in the underside of the lower half 52 into the space between the portion 50p continuous from the thick-walled portion 50n of the upper half 50 and the edge portion of the lower half 52 along the edge portions of the two halves, which are joined by the resulting frictional force. Note that the thick-walled portion 50n of the upper half 50 forms a stepped portion 50t at the lower end to prevent the entrance of dirt and dust into the interior defined by the upper and lower halves.

To cancel the joint between the upper and lower halves of the magnetic tape cassette according to the embodiment under consideration, a predetermined disengaging member may be inserted into the disengagement holes 50i in the thick-walled portion 50n of the upper half 50 to eject the spring pins 10.

We now describe a recording media cartridge according to the second aspect of the invention with reference to FIGS. 5-10.

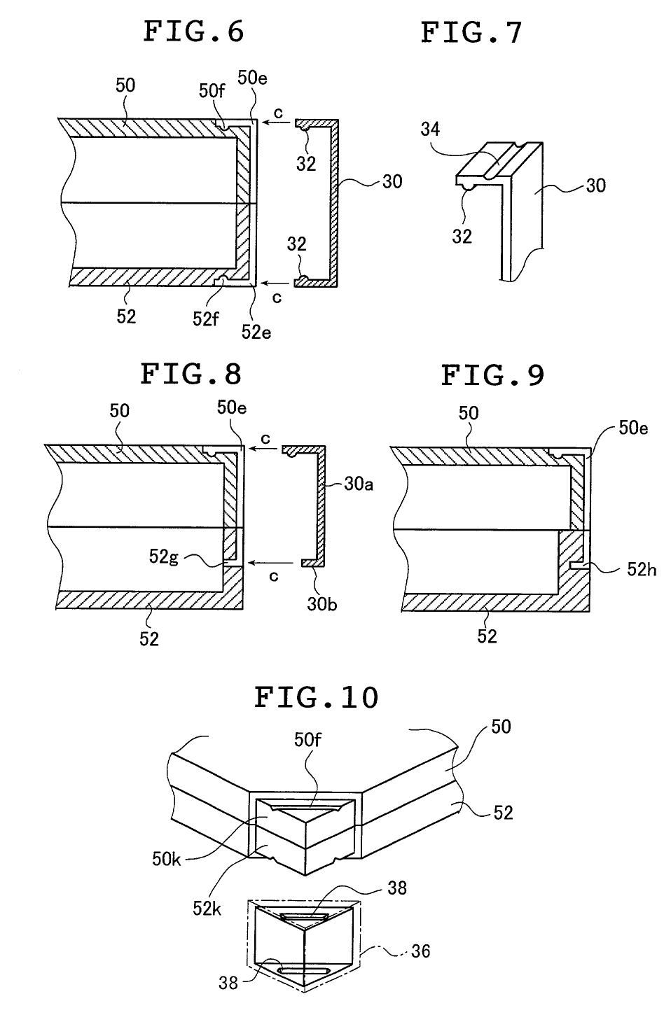

FIG. 5 is a partial enlarged perspective view showing how an upper half is combined with a lower half to make a magnetic tape cassette according to an embodiment of the second aspect of the invention. FIG. 6 shows a section of a fitting groove portion in the magnetic tape cassette. Again, the description of the general construction of the magnetic tape cassette which was already given by reference to FIGS. 61 and 62 is omitted and only the essential points are described below.

In FIGS. 5 and 6, numerals 50 and 52 refer to the upper half and the lower half, respectively, of the aforementioned magnetic tape cassette and these two halves are shown to be joined by fitting an engaging member 30 in fitting grooves 50e and 52e (see FIG. 6). The fitting grooves 50e and 52e in which the engaging member 30 is to be fitted are preferably provided in positions near the four corners of the magnetic tape cassette. The magnetic tape cassette according to the embodiment under consideration has no need to use bosses that are necessary to assemble the upper and lower halves by means of screws.

As FIG. 6 shows, the engaging member 30 is a U-shaped part that is generally formed of a thin sheet and the inner surfaces of the areas in opposite end portions that engage the upper and lower halves (i.e., the horizontal areas in FIG. 6) are preferably provided with projections (or linear ridges) 32 that engage recesses (or slots) 50f and 52f provided on the corresponding surfaces of the upper half 50 and the lower half 52 which are to be engaged by contact with the engaging member 30.

In addition to forming the projections (or linear ridges) 32 that engage the recesses (or slots) 50f and 52f in the upper and lower halves, the surface of the engaging member 30 that is opposed to the wall surfaces of the upper and lower halves as well as the wall surfaces in themselves may be processed by a certain surface roughening technique and this is effective to increase the friction between the respective mating surfaces.

Specific examples of the surface roughening technique include providing fine steps, various knurls or a matte finish on the respective surfaces of the engaging member 30 that will contact the upper and lower halves. These are not the sole examples that can be employed and combining them with the conferring of tackiness is also effective.

Turning back to FIGS. 5 and 6, we will continue the explanation.

In the embodiment under consideration, the upper and lower halves are joined by inserting the engaging member 30 in the fitting groove 50e that is provided spanning the top surface and a lateral surface of the upper half 50 and in the fitting groove 52e that is provided spanning the bottom surface and a lateral surface of the lower half 52. For assembling purposes, the upper and lower halves are combined and the engaging member 30 is fitted sideways, as indicated by an arrow c in FIG. 6, until it comes into engagement with each half.

The above-mentioned engaging member 30 has a disengagement groove (or recess) 34 provided at least in its upper end portion as shown in FIG. 7. To disassemble the magnetic tape cassette, a tool such as a screw driver is applied to the disengagement groove (or recess) 34 and urged outwardly, whereupon the magnetic tape cassette can be easily disassembled.

FIG. 8 is a partial enlarged sectional view showing how an upper half is combined with a lower half to make a magnetic tape cassette according to another embodiment of the second aspect of the invention. In this embodiment, the shape of the engaging member 30a is such that one half of it has the same shape as the engaging member 30 in the first embodiment whereas the other half is inserted and fitted into a hole 52g made in a sidewall of the lower half 52.

To be specific, the upper half of the engaging member 30a shown in FIG. 8 is identical in shape to the engaging member 30 shown in FIG. 6 but its lower half is shorter than that of the engaging member 30; in addition, a bent portion 30b of the lower half of the engaging member 30a ends in a straight line, so it can be easily inserted and fitted into the hole 52g made in a sidewall of the lower half 52.

The orientation in mounting of the engaging member 30a as relative to the upper half 50 and the lower half 52 may be reversed from the case shown in FIG. 8. FIG. 9 illustrates a case where part of the lower half 52 is adapted to have a greater wall thickness than the remainder, with the engaging member 30a being inserted into a hole 52h which is not a through-hole but a blind hole. Again, the orientation in mounting of the engaging member 30a as relative to the upper half 50 and the lower half 52 may be reversed from the case shown in FIG. 9.

According to the embodiments described above, the upper half and the lower half of the magnetic recording cassette including the engaging member 30 or 30a are joined in a neat form having no steps and, hence, the cassette in an assembled state has a desired external appearance. The magnetic tape cassettes of these embodiments have an added advantage in that they will do no harm to the action of a drive in a record/reproduce apparatus when loaded thereon.

We next describe an embodiment in which the aforementioned engaging members 30 and 30a are replaced by an engaging member 36 in the form of a hollow right-angled triangular prism which is to engage a corner of the magnetic tape cassette. If the engaging member 36 in the form of a hollow right-angled triangular prism in this embodiment is to be used, a stepped portion 50k (or 52k) which is brought into engagement with the engaging member 36 need be provided at a corner of the upper half 50 (or the lower half 52) of the magnetic tape cassette as shown in FIG. 10.

The stepped portion 50k (or 52k) is formed by partially chipping the four surfaces of a corner of the upper half 50 (or the lower half 52) to smaller dimensions. The stepped portions 50k and 52k have recessed grooves 50f and 52f that are formed in the top surface and the bottom surface, respectively, and which are to engage linear ridges 38 formed on the inner surfaces of the engaging member 36 to be described later. The engaging means using the stepped portions 50k and 52k and the engaging member 36 is preferably provided at the four corners of the magnetic tape cassette.

In order to join the upper half 50 and the lower half 52 to make the magnetic tape cassette according to the embodiment under consideration, the engaging member 36 is fitted over the stepped portions 50k and 52k so that it covers them. As a result, the linear ridges 38 formed on the inner top and bottom surfaces of the engaging member 36 are brought into engagement with the recessed grooves 50f and 52f formed in the stepped portions 50k and 52k, respectively, of the magnetic tape cassette, whereupon the engaging member 36 engages the magnetic tape cassette to join the upper half 50 and the lower half 52.

Although not shown in FIG. 10, the engaging member 36 has a disengagement groove (or recess) provided at least in its top surface. To disassemble the magnetic tape cassette according to the embodiment under consideration, a tool such as a screw driver is applied to the disengagement groove (or recess) and urged outwardly, whereupon the magnetic tape cassette can be easily disassembled as in the case of the aforementioned engaging member 30.

In order to assure more positive engagement between the magnetic tape cassette and the engaging member 36, it is effective to apply a treatment such as ultrasonic welding to the engaging portions of the engaging member 36 as it has been fitted over the magnetic tape cassette. This option should preferably be considered in the embodiment under consideration.

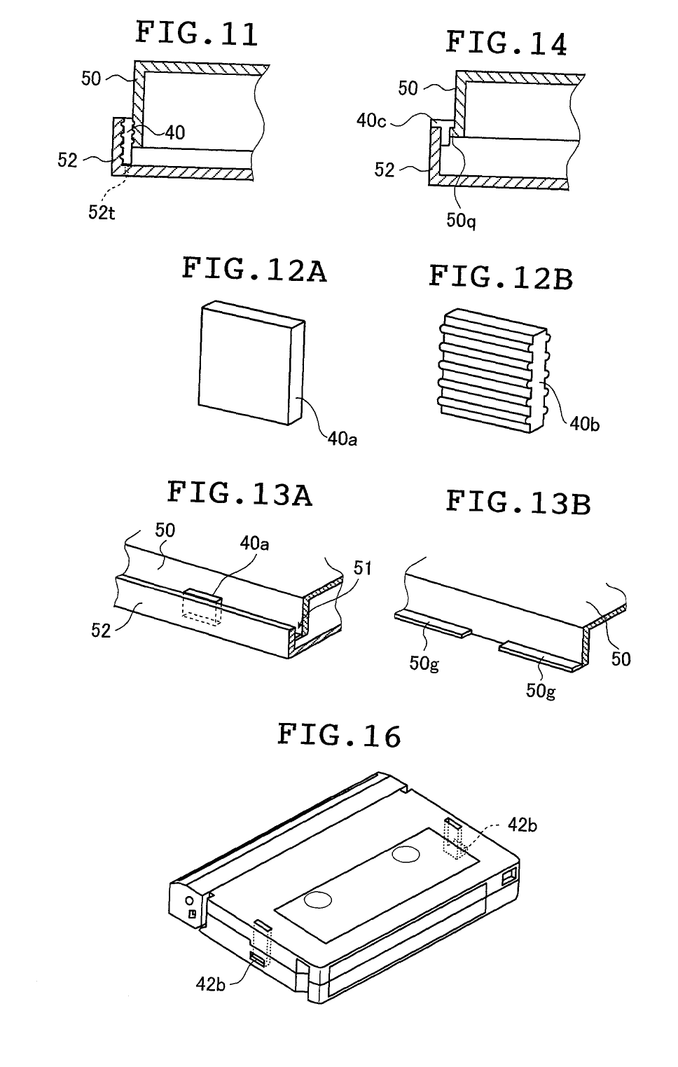

We next describe a recording media cartridge according to the third aspect of the invention with reference to FIGS. 11-14.

FIG. 11 is a partial enlarged sectional view showing how an upper half is joined with a lower half to make a magnetic tape cassette according to an embodiment of the third aspect of the invention. Again, the description of the general construction of the magnetic tape cassette which was already given by reference to FIGS. 61 and 62 is omitted and only the essential points are described below.

In FIG. 11, numerals 50 and 52 refer to the upper half and the lower half, respectively, of the aforementioned magnetic tape cassette and these two halves are shown to be joined by fitting an engaging plate 40. Detailed structures for the engaging plate 40 which is used to establish a joint are shown in FIGS. 12A and 12B. The engaging plate 40 is preferably provided in positions near the four corners of the magnetic tape cassette.

As FIGS. 12A and 12B show, the engaging plate 40 is a thin sheet of component; the engaging plate indicated by 40a in FIG. 12A has been surface roughened as will be described later to have a fine texture and the engaging plate indicated by 40b in FIG. 12B is provided with comparatively large steps (linear ridges). In order to increase the friction with respect to a sidewall of the upper (or lower) half which is to be engaged by contact with the engaging plate 40, a lateral side of the engaging plate 40 is preferably subjected to a certain type of surface roughening as mentioned above.

Specific examples of the surface roughening technique include providing fine steps, various knurls or a matte finish on the respective surfaces of the engaging plate 40 (or 40a) that will contact the upper and lower halves. These are not the sole examples that can be employed and combining them with the conferring of tackiness is also effective.

Turning back to FIG. 11, we will continue the explanation.

In the embodiment under consideration, the lower half 52 is so designed that it is somewhat larger than the upper half 50 and that at least two opposed sides of the upper half 50 fit into the lower half 52 (the two halves overlap in the direction of thickness). Then, a small gap will result between the outer surface of the upper half 50 and the inner surface of the lower half 52 and the engaging plate 40 is inserted into this gap, whereby the upper and lower halves are joined. Hence, in the embodiment shown, the outer surface of the upper half 50 is not flush with the outer surface of the lower half 52 but is offset from the latter.

This point is described below more specifically with reference to FIGS. 13A and 13B which show enlarged the area in which the engaging plate 40a is inserted. As FIG. 13A shows, a gap 51 (indicated by an arrow) is formed between the upper and lower halves. In the embodiment under consideration, the engaging plate 40 is inserted into this gap 51. There is no problem if the length of the engaging plate 40 (as measured from the front side of the magnetic tape cassette toward the rear side) is sufficient to cover the whole area of the gap. However, if the engaging plate 40 is not long enough, prevention of dirt and dust from getting into the gap 51 need be considered.

In order to prevent the ingress of dirt and dust, the upper half 50 is preferably provided with a visor 50g which, as shown in FIG. 13B, has a certain area cut away that is to contact the engaging plate 40a. The visor 50g may be provided on the lower half 52. In practice, the engaging plate 40 (including 40a and 40b) has a thickness of about 0.5 mm and the intended dust prevention can be achieved by increasing the length of the engaging plate 40 (as measured from the front side of the magnetic tape cassette toward the rear side).

If, as in the case of discarding, a need arises to disassemble the magnetic tape cassette according to the embodiment under consideration, an end of the engaging plate 40 that has been brought into engagement with the cassette in the way described above is pulled out by means of a pin-shaped disassembling tool to easily detach the plate. Alternatively, a disengagement hole 52t may be formed in the lower half 52 as shown in FIG. 11 and a disengaging tool is inserted into this hole to push out the engaging plate 40.

FIG. 14 is a partial enlarged sectional view showing how an upper half is combined with a lower half to make a magnetic tape cassette according to another embodiment of the third aspect of the invention. The magnetic tape cassette according to this embodiment uses an engaging plate 40c with a stopper that assures better stability in the operation involved in inserting the engaging plate 40.

In the embodiment under consideration, the lower half 52 is so designed that it is somewhat larger than the upper half 50 and the lower end of the upper half 50 is formed as an engaging portion 50q that projects toward the lower half 52, with at least two opposed sides of the upper half 50 fitting into the lower half 52 (the two halves overlapping in the direction of thickness). The stoppered engaging plate 40c is pushed into the gap between an edge portion of the lower half 52 and the engaging portion 50q of the upper half 50 until they come into contact with the stopper, whereby the two halves are joined together.

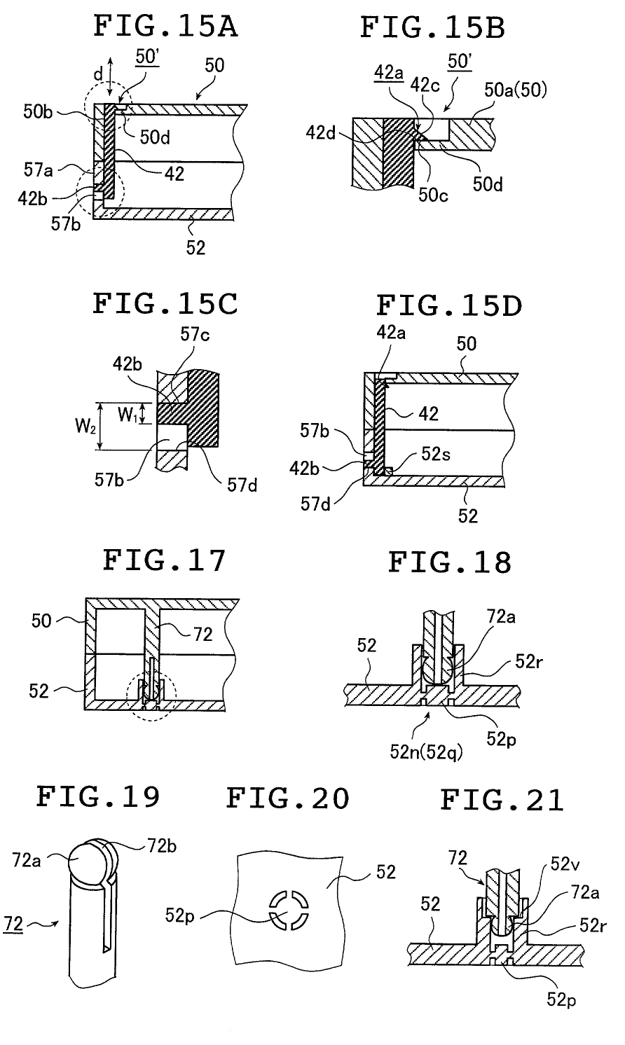

We next describe a recording media cartridge according to the fourth aspect of the invention with reference to FIGS. 15A-16.

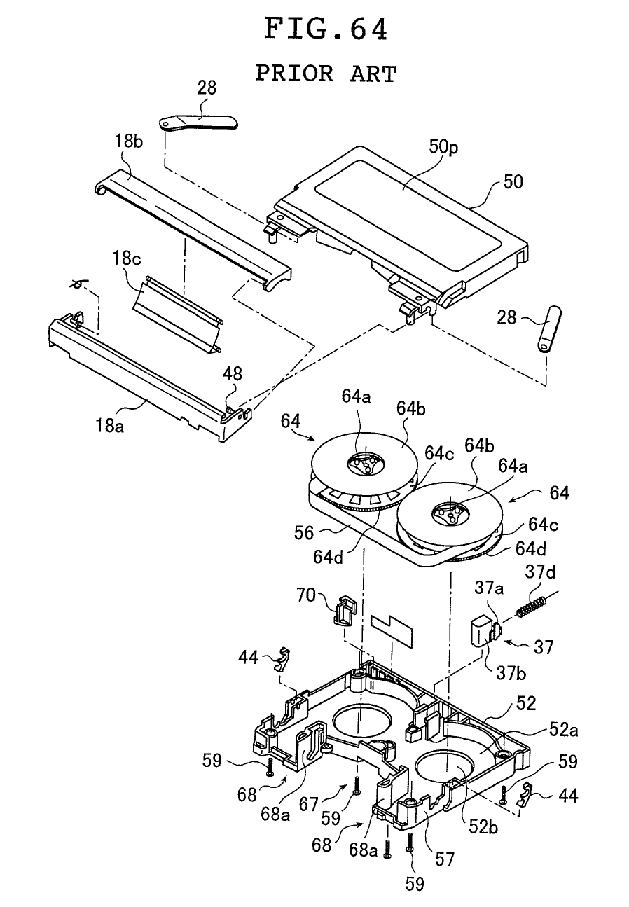

FIGS. 15A-15D are partial enlarged sectional views showing how an upper half is combined with a lower half to make a magnetic tape cassette according to an embodiment of the fourth aspect of the invention. Again, the description of the general construction of the magnetic tape cassette which was already given by reference to FIG. 64 is omitted and only the essential points are described below.

FIG. 15A is a sectional view illustrating a structure the magnetic tape cassette according to the embodiment under consideration adopts to join the upper half 50 and the lower half 52 by means of an engaging member 42. FIGS. 15B and 15C are enlarged views of the two areas in FIG. 15A that are enclosed with dashed circles.

The engaging member 42 is a generally prismatic component which has an upper engaging end 42a and a lower engaging end 42b. As FIG. 15B shows, the engaging end 42a projects from the upper end portion of the engaging member 42 and its cross section is generally like a visor having an inclined top 42c. The engaging end 42b projects from an almost bottom end of the engaging member 42 and has a generally rectangular cross section.

The top plate 50a of the upper half 50 is provided with an upper half engaging portion 50′ that consists of a through-hole 50b through which the upper engaging end 42a of the engaging member 42 can pass and an engaging step portion 50d that is formed continuous from the through-hole 50b and which has an engaging surface 50c for engagement by the underside 42d of the engaging end 42a. As shown enlarged schematically in FIG. 15B, it is in this upper half engaging portion 50′ that the underside 42d of the engaging end 42a of the engaging member 42 engages the engaging surface 50c of the engaging step portion 50d.

A sidewall 57a of the lower half 52 has a lower half engagement hole 57b into which the engaging end 42b of the engaging member 42 is fitted to establish engagement. The engaging end 42b formed in a generally rectangular cross section is fitted into the lower half engagement hole 57b. In order to ensure that the engaging end 42b can slide vertically from the lower half 52 to the upper half 50 and vice versa (in the directions indicated by an arrow d in FIG. 15A), the lower half engagement hole 57b has a vertical opening width W₂ greater than the vertical width W₁ of the engaging end 42b (W₁<W₂). The difference between W₂ and W₁ (W₂−W₁) represents the distance over which the engaging member 42 can slide vertically.

To construct the case body of the magnetic tape cassette by joining the upper half 50 and the lower half 52, the following procedure is taken: as shown in FIG. 15A, the engaging member 42 is placed between the upper half 50 and the lower half 52 to extend along the inner surface of a sidewall of the case body and the upper end portion of the engaging member 42 is passed through the through-hole 50b whereas the underside 42d of the engaging end 42a provided on the upper end portion of the engaging member 42 is brought into contact with the engaging surface 50c of the engaging step portion 50d of the upper half 50, whereby the engaging member 42 is brought into engagement with the upper half 50 (see FIG. 15B). Speaking of the engaging end 42b which is in an almost bottom end portion of the engaging member 42, it is fitted into the lower half engagement hole 57b in the sidewall 57a of the lower half 52 and contacts the inner top surface 57c of the lower half engagement hole 57b, whereby it comes into engagement with the lower half 52 (FIG. 15C).

In order to disassemble the magnetic tape cassette, the upper half 50 is brought out of engagement with the lower half 52 to disassemble the case body by the following procedure. The engaging end 42b which is in engagement with the lower half engagement hole 57b as shown in FIG. 15A is pushed down to the inner bottom surface 57d (see FIG. 15C) of the lower half engagement hole 57b as shown in FIG. 15D, whereupon the engaging end 42a and the engaging step portion 50d deform such that the engaging end 42a moves downward and passes by the engaging step portion 50d so that it becomes positioned below the engaging step portion 50d to be disengaged from the upper half 50. As a result, the joint between the upper half 50 and the lower half 52 is cancelled. If desired, a position regulating rib 52s may be provided on the bottom surface of the lower half 52 so that the lower end of the engaging member 42 which has moved to the disengagement position is held between the rib 52s and the inner bottom surface 57d of the lower half 52; this design contributes not only to regulating the position of the lower end of the engaging member 42 but also to achieving more effective dust prevention.

In order to join the upper half 50 and the lower half 52 again, one may simply push the engaging end 42b upward, whereupon an action reverse to the one described above causes the upper half 50 and the lower half 52 to be joined together by means of the engaging member 42; the result is the case body having two engaging ends 42b as shown in FIG. 16. In this case, the tip of the engaging step portion 50d slides along the inclined top 42c of the engaging end 42a, allowing the latter to go up and smoothly pass by the engaging step portion 50d to come into engagement with the engaging surface 50c.

We next describe a recording media cartridge according to the fifth aspect of the invention with reference to FIGS. 17-25.

FIG. 17 is a partial enlarged sectional view showing how an upper half is combined with a lower half to make a magnetic tape cassette according to an embodiment of the fifth aspect of the invention. FIG. 18 shows enlarged the area of FIG. 17 which is enclosed with a dashed circle and it illustrates how engagement is realized by an engaging means using a coupling strut having a split bulging portion at its tip.

Again, the description of the general construction of the magnetic tape cassette which was already given by reference to FIGS. 61 and 62 is omitted and only the essential points are described below.

In FIGS. 17 and 18, numerals 50 and 52 refer to the upper and lower halves, respectively, of the aforementioned magnetic tape cassette and they are shown to be joined together by the aforementioned engaging means using a coupling strut 72 having a split bulging portion 72a at its tip. The positions where the engaging means is provided are preferably near the four corners of the magnetic tape cassette.

As FIGS. 17 and 18 show, the engaging means employed in the embodiment under consideration is of such a mechanism that the aforementioned split bulging portion 72a at the tip of the coupling strut 72 which is provided on the underside of the upper half 50 (said split bulging portion is hereunder referred to simply as a bulging portion) is fitted into an engagement hole 52n formed in a boss 52r on the lower half 52. As shown, a cover member 52p which will easily break upon application of a comparatively small force is provided in the aforementioned engagement hole 52n in the lower half 52.

In order to cancel the joint established between the upper and lower halves by the above-described engaging means, the bulging portion 72a of the coupling strut 72 (see FIG. 19) may be pushed out of the engagement hole 52n in the lower half 52. However, unless the cover member 52p is broken, one cannot proceed to the next step (which, in the embodiment under consideration, involves pushing the coupling strut 72 and disassembling the magnetic tape cassette). Thus, the cover member 52p may well be considered as a means for discouraging the user from disassembling the magnetic tape cassette.

To be more specific, the cover member 52p is of a shape that is obtained by working an area of the bottom surface of the lower half 52 which still remains intact after the bulging portion 72a is received within the engagement hole 52n that is provided in a thick-walled portion formed up above. Structurally, the cover member 52p is connected to the inner surface of the engagement hole 52n by two to four thin bridges and can be broken by simply applying a comparatively small force (see the bottom view in FIG. 20).

Note that the inner surface of that area of the engagement hole 52n which is to receive the bulging portion 72a may be roughened. Specific examples of the surface roughening technique include providing fine steps, various knurls or a matte finish on the inner surface of the engagement hole 52n. These are not the sole examples that can be employed and combining them with the conferring of tackiness is also effective.

In order to assemble the magnetic tape cassette of this design according to the embodiment under consideration, the following procedure is taken: after positioning or placing predetermined components in the interior, the upper half 50 is brought into registry with the lower half 52; the bulging portions 72a at the tips of four coupling struts 72 on the upper half 50 are inserted into the corresponding engagement holes 52n in the lower half 52; as each bulging portion 72a is compressed in slidable contact with the inner peripheral surface of the corresponding engagement hole 52n, a split 72b in the bulging portion 72a causes the coupling strut 72 to deform elastically in the axial direction, whereupon it constricts sufficiently to be fitted into the engagement hole 52n.

As a result, the upper half 50 and the lower half 52 can be joined into an integral unit by one action without screw- or otherwise-based fastening operations.

In order to disassemble the magnetic tape cassette, the following procedure need be taken: a tool is inserted into each of the engagement holes 52n (which also serve as disengagement holes 52q) from the bottom of the lower half 52; the tip of the bulging portion 72a of the coupling strut 72 is pressed with the inserted tool so that the coupling strut 72 is pushed up toward the upper half 50 and forced out of the engagement hole 52n.

However, in the magnetic tape cassette according to the embodiment under consideration, the surface of each engagement hole 52n (in the underside of the lower half 52) is usually such that the tip of the bulging portion 72a of the coupling strut 72 is covered with the cover member 52p and if the latter remains intact, the tip of the bulging portion 72a of the coupling strut 72 cannot be depressed.

To deal with this situation, the cover member 52p in the engagement hole 52n is first broken by the pressing action of the tool and, subsequently, the broken cover member 52p is further pressed into the engagement hole 52n until the tip of the bulging portion 72a of the coupling strut 72 is pushed up so that it comes out of the engagement hole 52n. If desired, the broken cover member 52p may be removed before the second stage of the disassembling process starts.

By this second stage of pressing action, the elastic deformation of the bulging portion 72a is cancelled, causing it to be disengaged from the engagement hole 52n. Thereafter, the upper half 50 is further lifted up so that it is disconnected from the lower half 52, whereupon the two halves can be easily taken apart.

In the magnetic tape cassette according to the embodiment under consideration, the tip of the coupling strut 72 on the upper half 50 need not be completely inserted into the engagement hole 52n in the lower half 52 but the bulging portion 72a may be stopped halfway down the engagement hole 52n so that the upper half 50 is temporarily fitted on the lower half 52; this offers the advantage that if required during certain operations in the production process such as mounting, dismounting and fitting-in of components, the upper half 50 can be easily separated from the lower half 52 to improve operation efficiency.

As a further advantage, the upper half 50 as fitted temporarily on the lower half 52 is not liable to separate from the latter, providing a sufficiently rugged structure that the efficiency in handling of the magnetic tape cassette on the production line is greatly improved.

Note that the orientation in mounting of the coupling strut 72 as relative to the upper half 50 and the lower half 52 may be reversed from the case shown in FIG. 17.

As shown in FIG. 21, the body (cylindrical portion) of the coupling strut 72 may be adapted to have a larger diameter than the bulging portion 72a at its tip so that the boss 52r in which the engagement hole 52n is formed is provided with a stepped portion 52v which is to be contacted by the body of the coupling strut 72; this is effective to ensure that the coupling strut 72 can be correctly positioned with respect to the engagement hole 52n. The coupling strut 72 of this structure offers the additional advantage of facilitating the molding of the coupling strut 72.

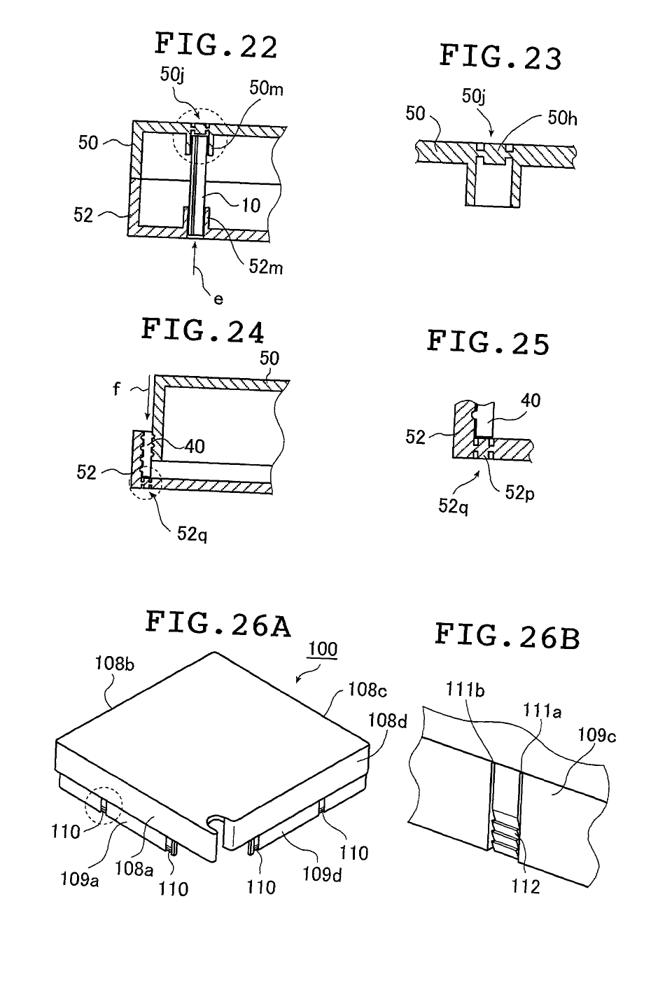

The upper half and the lower half may be joined by inserting a spring pin indicated by 10 in FIG. 22. In this system (see FIG. 1), too, a disengagement hole 50j with a cover member 50h (see FIG. 23 which is a partial enlarged view of FIG. 22) may be provided so that for disassembling purposes, the spring pin 10 is pushed out in a direction opposite to the direction of its insertion (indicated by an arrow e in FIG. 22).

The upper half and the lower half may also be joined by inserting a wedge-shaped engaging member indicated by 40 in FIG. 24. In this system (see FIG. 11), too, a disengagement hole 52q with a cover member 52p (see FIG. 25 which is a partial enlarged view of FIG. 24) may be provided so that for disassembling purposes, the wedge-shaped engaging member 40 is pushed out in a direction opposite to the direction of its insertion (indicated by an arrow f in FIG. 24).

It should also be noted that the cover members to be provided in the disengagement holes shown in FIGS. 17-25 may be prepared as elements that are separate from the upper half (or the lower half) and which are to be pressed into those disengagement holes. In this alternative case, such cover members may especially be formed of different materials than the upper and lower halves, provided that they are most appropriate for such cover members.

We next describe a recording media cartridge according to the sixth aspect of the invention with reference to FIGS. 26A-38B.

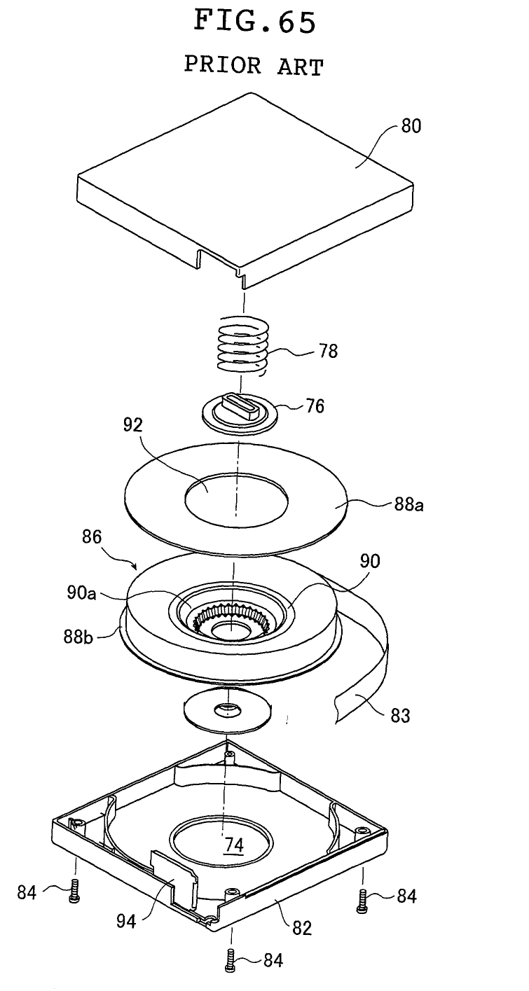

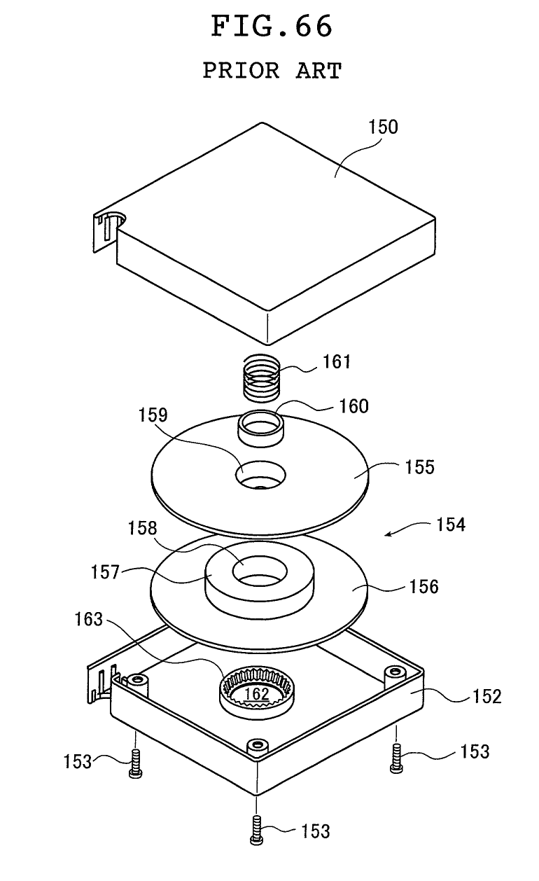

On the pages that follow, the present invention is described in detail with reference to magnetic tape cartridges of a one-reel type (see FIGS. 65 and 66) which are an embodiment of the recording media cartridge of the invention and which have the structure shown in FIGS. 26A-38B. Of course, this is not the sole case of the invention and it can be applied to magnetic tape cartridges of a two-reel type (see FIGS. 61, 62 and 63). In the following description, the overall constructions of the magnetic tape cartridges shown in FIGS. 64-66 and the description of identical members and components are omitted and the main discussion is directed to the lower engaging portion and the upper engaging portion.

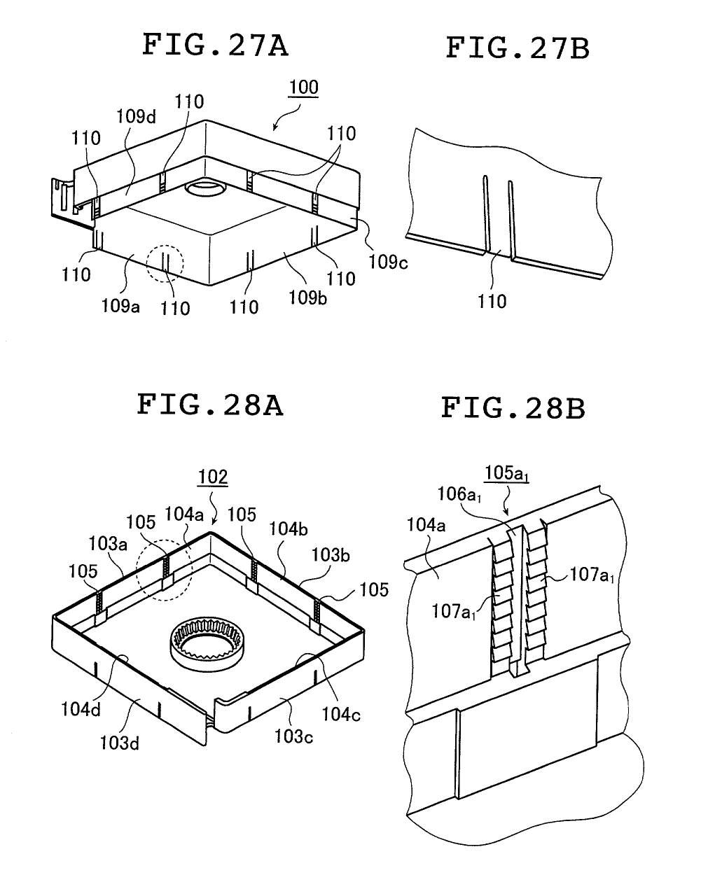

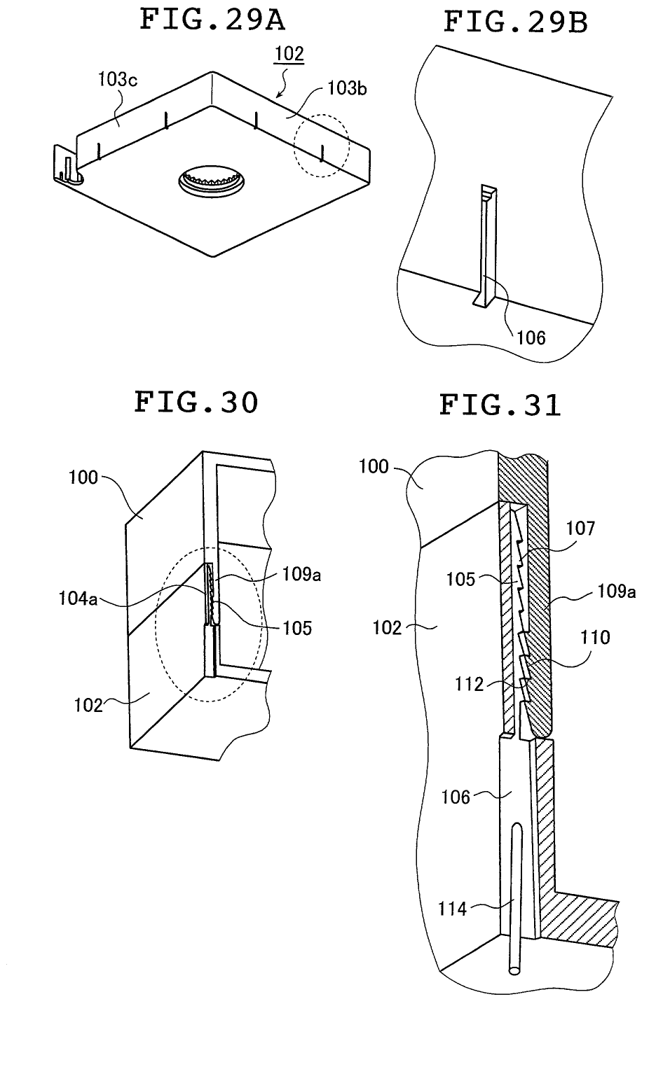

Let us start with FIGS. 26A-29B, which are perspective views and partial enlarged views of the upper and lower halves of a magnetic tape cartridge according to a first embodiment of the sixth aspect of the invention. The magnetic tape cartridge has a case body consisting of an upper half 100 for accommodating magnetic tape and a lower half 102; the upper half 100 is shown in perspective in FIG. 26A as seen from above and in FIG. 27A as seen from below whereas the lower half 102 is shown in perspective in FIG. 28A as seen from above and in FIG. 29A as seen from below.

As show n in FIG. 28A, the lower half 102 h as four sidewalls 103a, 103b, 103c and 103d, upper edge sides 104a, 104b, 104c and 104d provided as setbacks on the inner surfaces of these sidewalls, and engaging toothed portions 105, two each being provided on the upper edge sides. To take an engaging toothed portion 105a₁ as a typical example, it is shown enlarged in FIG. 28B and consists of a groove 106a₁ cut in the upper edge side 104a to extend from the top edge toward the bottom and a pair of saw-toothed engaging portions 107a₁ that are formed on opposite sides of the groove 106a₂ as projecting toward the bottom. As shown in FIGS. 29A and 29B, the groove 106 (106a₁) is bored through a sidewall of the lower half 102 to become exposed to the outside and extends from the top edge of the upper edge side toward the bottom.

As shown in FIGS. 26A and 27A, the upper half 100 has four sidewalls 108a, 108b, 108c and 108d and lower edge sides 109a, 109b, 109c and 109d provided as setbacks on the inner surfaces of these sidewalls. The lower edge sides 109a, 109b, 109c and 109d are fitted to the upper edge sides 104a, 104b, 104c and 104d of the lower half to form the lateral sides of the case body for the magnetic tape cartridge.

The lower edge sides 109a, 109b, 109c and 109d have engaging pawls 110 provided in positions that correspond to the engaging toothed portions 105 of the lower half 102. Taking an engaging pawl 110a₁ on the lower edge side 109c as a typical example, the engaging pawl 110 is shown enlarged schematically in FIGS. 26B and 27B and formed as a lip that is defined by two grooves 111a and 111b cut in the lower edge side 109c on opposite sides of the pawl; it also has at its tip a saw-toothed engaging pawl portion 112 that is formed on the outer lateral surface of the lower edge side 109c as projecting toward the top. The engaging pawl portion 112 meshes with the engaging toothed portion 105 of the lower half 102.

In order to assemble the magnetic tape cartridge having the structure shown in FIGS. 26A-29B, the following procedure is taken: after positioning or placing predetermined components in the interior, the upper half 100 is brought into registry with the lower half 102; then, as FIGS. 30 and 31 show, the lower edge sides 109a (109b, 109c, 109d) of the upper half 100 are fitted to the corresponding upper edge sides 104a (104b, 104c, 104d) of the lower half 102; at the same time, the engaging pawl portions 112 of the engaging pawls 110 provided on the lower edge sides 109a (109b, 109c, 109d) of the upper half 100 mesh with the saw-toothed engaging portions 107 of the engaging toothed portions 105, two each being provided on the upper edge sides 104a (104b, 104c, 104d) of the lower half 102, whereby the lower half 102 and the upper half 100 are joined together to form an integral unit that makes the case body. As a result, the upper half 100 and the lower half 102 can be joined by one action without screw- or otherwise-based fastening operations.

In order to disassemble the magnetic tape cartridge, the following procedure is taken: as schematically shown in FIG. 31, a tool 114 is inserted into the grooves 106 in the engaging toothed portions 105 from the bottom of the lower half 102; the engaging pawl portions 112 of the upper half 100 is pushed up with the inserted tool 114 to cancel the meshing between each engaging pawl portion 112 and the corresponding saw-toothed engaging portion 107; as a result, the upper half 100 is decoupled from the lower half 102 and the two halves can be easily taken apart.

In the magnetic tape cartridge according to the embodiment under consideration, the saw-toothed engaging portions 107 of the lower half 102 need not completely mesh with the engaging pawl portions 112 of the upper half 100 but one or two pawls in each engaging pawl portion 112 may mesh with the corresponding saw-toothed engaging portion 107 so that the upper half 100 is temporarily fitted on the lower half 102; this offers the advantage that if required during certain operations in the production process such as mounting, dismounting and fitting-in of components, the upper half 100 can be easily separated from the lower half 102 to improve operation efficiency. As a further advantage, the upper half 100 as fitted temporarily on the lower half 102 is not liable to separate from the latter, providing a sufficiently rugged structure that the efficiency in handling of the magnetic tape cartridge on the production line is greatly improved.

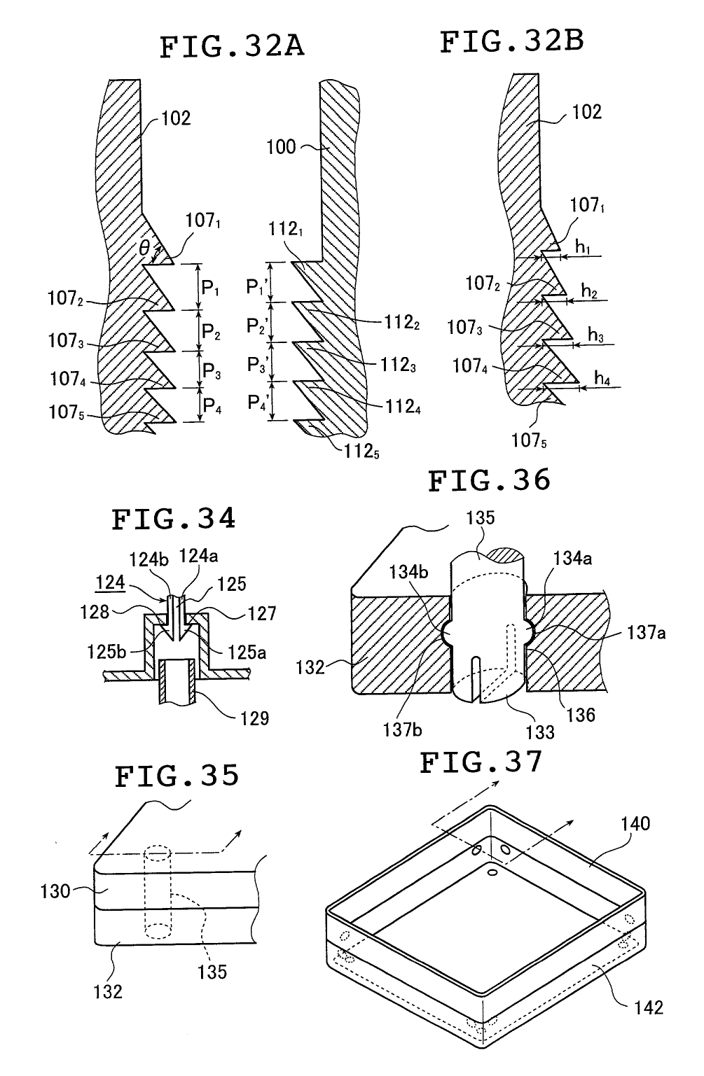

Suppose here that the saw-toothed engaging portion 107 of the engaging toothed portion 105 on the lower half 102 consists of engaging teeth 107₁, 107₂, 107₃, 107₄, . . . which are arranged at intervals (on pitches) of P₁, P₂, P₃, P₄, . . . and also suppose that the engaging pawl 110 on the upper half 100 has engaging pawl portions 112₁, 112₂, 112₃, 112₄, . . . which are arranged on pitches of P₁′, P₂′, P₃′, P₄′, . . . . As shown in FIG. 32A, either the group of P₁, P₂, P₃, P₄, . . . or the group of P₁′, P₂′, P₃′, P₄′, . . . or both groups are preferably such that the pitch decreases gradually in the increasing order of subscripts 1, 2, 3 and 4. In a particular case, the engaging teeth 107 and the engaging pawl portions 112 may be so designed that the pitch increases gradually in one group but remains the same in the other group—either the relationship (1) or (2) set forth below is satisfied. Given this condition, if all engaging teeth 107ₙ mesh with all engaging pawl portions 112ₙ, specifically in the case shown in FIG. 32A where the lower half 102 has only five engaging teeth 107 and the upper half 100 has only five engaging pawl portions 112, if perfect mesh between the engaging tooth 107₅ and the engaging pawl portion 112₅ is obtained, any backlash can be effectively absorbed to produce a rattle-free and tight fit.

In the case of a temporary fit in which only the upper group of engaging teeth 107 on the lower half 102 mesh with the lower group of engaging pawl portions 112 on the upper half 100, as exemplified by the engaging teeth 107₁ and 107₂ which mesh with the engaging pawl portions 112₄ and 112₅ (see FIG. 32A in which the lower half 102 has only five engaging teeth 107 and the upper half 100 has only five engaging pawl portions 112), the fit is loose enough to be easily cancelled. This offers the advantage that if required during certain operations in the production process such as mounting, dismounting and fitting-in of components, the upper half 100 can be easily separated from the lower half 102 to improve operation efficiency. As a further advantage, the upper half 100 as fitted temporarily on the lower half 102 is not liable to separate from the latter, providing a sufficiently rugged structure that the efficiency in handling of the magnetic tape cartridge on the production line is improved. It should, however, be noted that in the following relations, ΔP which is the difference between adjacent Pₙ and Pₙ₊₁ (n is an integer of one or more) or ΔP′ which is the difference between adjacent Pₙ′ and Pₙ₊₁′ (n is an integer of one or more) is set to a very small value:

P₁>P₂>P₃>P₄ and P₁′=P₂′=P₃′=P₄′ (1)

P₁=P₂=P₃=P₄ and P₁′>P₂′>P₃′>P₄′ (2)

Suppose here that the engaging teeth 107₁, 107₂, 107₃, 107₄, . . . of the saw-toothed engaging portion 107 of the engaging toothed portion 105 on the lower half 102 have heights, namely crest-to-root distances, of h₁, h₂, h₃, h₄, . . . If desired, the engaging teeth 107 may be formed in such a way that the height of engaging tooth 107ₙ increases gradually toward the bottom of the lower half 102 (h₁<h₂<h₃<h₄ . . . ) with a very small increment as shown in FIG. 32B. This is another effective way to reduce backlash and realize a close fit between the upper half 100 and the lower half 102.

The cross-sectional angle of the engaging tooth 107ₙ is indicated by θ in FIG. 32A and is advantageously in the range of about 25-85 degrees for the respective engaging teeth 107n. The crest of each engaging tooth 107ₙ may be provided with a fillet or chamfered and this is effective in increasing the tooth strength.

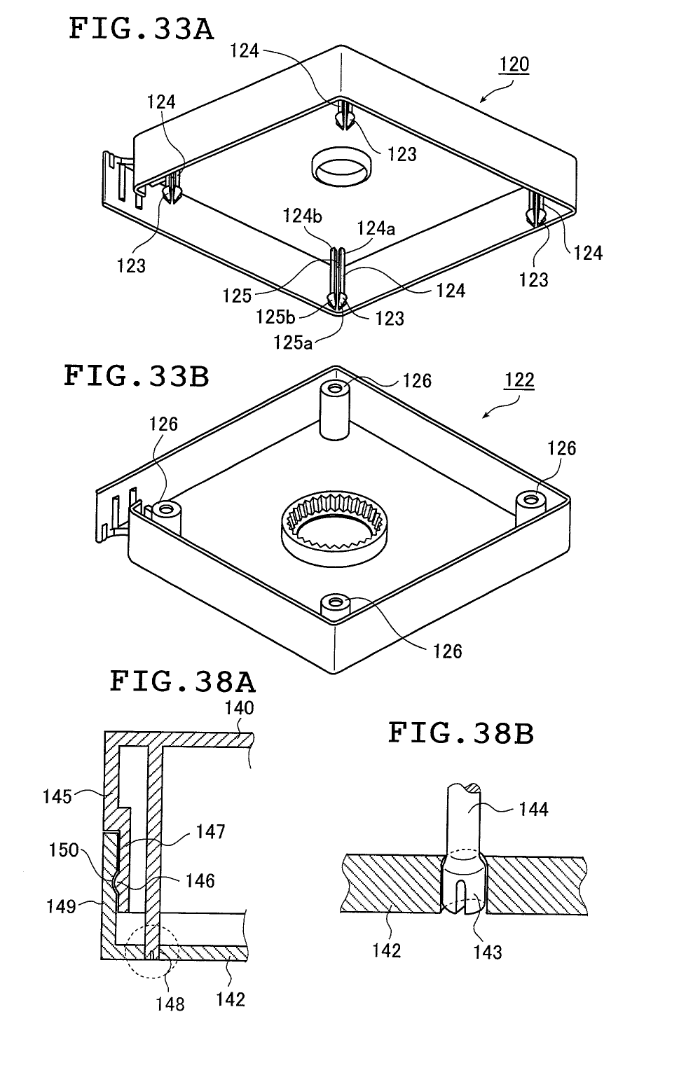

We next describe another embodiment of the sixth aspect of the invention. FIGS. 33A and 33B show an upper half 120 and a lower half 122, respectively, of the magnetic tape cartridge according to this embodiment and FIG. 34 is a partial enlarged schematic cross section of the cartridge. The magnetic tape cartridge has a case body that consists of the upper half 120 and the lower half 122 to contain magnetic tape.

As FIG. 33A shows, the magnetic tape cartridge according to the embodiment under consideration has an elastically deformable coupling member 124 with an engaging pawl 123 at its tip directed toward the lower half 122, that is provided at the four internal corners of the upper half 120. The coupling member 124 consists of two opposed semicylindrical members 124a and 124b with a straight groove 125 therebetween. The semicylindrical members 124a and 124b have tips 125a and 125b each like an arrowhead in cross section. The engaging pawl 123 consists of the two opposed tips 125a and 125b.

As FIG. 33B shows, the lower half 122 has four fitting holes 126 formed at the four internal corners in registry with the four coupling members 124 so that the latter can be fitted into these holes. As shown in FIG. 34, each fitting hole 126 has an internal engaging portion 128 that engages a shoulder 127 of the engaging pawl 123 of the inserted coupling member 124.

To assemble the magnetic tape cartridge having the structure shown in FIGS. 33A, 33B and 34, the following procedure is taken: after positioning or placing predetermined components in the interior, the upper half 120 is brought into registry with the lower half 12 and 2 and the tips of the four coupling members 124 on the upper half 120 are inserted into the fitting holes 126; in the engaging pawl 123 of each coupling member 24, as the arrowhead-shaped tips 125a and 125b of the semicylindrical members 124a and 124b are compressed in slidable contact with the inner peripheral surface at the mouth of the corresponding fitting hole 126, the straight groove 125 causes the engaging pawl 123 to deform elastically in the axial direction so that it is inserted into the fitting hole 126, whereupon the shoulder 127 comes into engagement with the internal engaging portion 128 of the fitting hole 126. As a result, the upper half 120 and the lower half 122 can be joined to form an integral unit as the case body by one action without screw- or otherwise-based fastening operations.

In order to disassemble the magnetic tape cassette, the following procedure is taken: a tool 129 in the form of a hollow cylinder having an inside diameter corresponding to the dimension of each of the tips 125a and 125b of the coupling member 124 is inserted into the fitting hole 126 from the bottom of the lower half 122 as shown in FIG. 34; the tips 125a and 125b of each coupling member 124 are pressed with the tip of the inserted tool 129 so that the engaging pawl 123 is deformed elastically in the axial direction, whereupon the shoulder 127 is disengaged from the internal engaging portion 128; as a result, the upper half 120 is decoupled from the lower half 122, whereupon the two halves can be easily taken apart. Disengagement can be accomplished by a one-directional action and the upper half 120 and the lower half 122 can be taken apart if the tool 129 is inserted in a direction that splits the cartridge into the two halves.

We next describe yet another embodiment of the sixth aspect of the invention. The magnetic tape cartridge having the structure shown in FIGS. 35 and 36 according to the embodiment under consideration has a case body that consists of an upper half 1301 and a lower half 132 to accommodate magnetic tape.

The magnetic tape cartridge has a coupling strut 135 projecting from the four internal corners of the upper half 130 and, as shown in section in FIG. 36, with part taken away, the coupling strut 135 has a split portion 133 at its tip and outwardly bulging bumps 134a and 134b in areas halfway down the strut.

The lower half 132 has mounting holes 136 into which the coupling struts 135 are to be inserted. As also shown in FIG. 36, recesses 137a and 137b into which the outwardly bulging bumps 134a and 134b on the coupling strut 135 are to be fitted are provided in the inner surface of each of the mounting holes 136 in positions that correspond to the bumps 134a and 134b.

In order to assemble the magnetic tape cartridge having the structure shown in FIGS. 35 and 36, the following procedure is taken: after positioning or placing predetermined components in the interior, the upper half 130 is brought into registry with the lower half 132; the tips of the four coupling struts 135 on the upper half 130 are inserted into the mounting holes 136; as the tip of each coupling strut 135 is compressed in slidable contact with the inner surface of the mounting hole 136, the split portion 133 at the tip of the coupling strut 135 deforms elastically in the axial direction so that the coupling strut 135 passes through the mounting hole 136 in spite of the outwardly bulging bumps 134a and 134b, allowing the bumps 134a and 134b to fit into the recesses 137a and 137b made in the inner surface of the mounting hole 136. As a result, the upper half 130 and the lower half 132 can be joined integrally to form the case body by one action without screw- or otherwise-based fastening operations.

In order to disassemble the magnetic tape cartridge, the following procedure is taken: a tool is inserted into each of the mounting holes 136 from the bottom of the lower half 132; the tip of the split portion 133 of the coupling strut 135 is pressed with the inserted tool so that the coupling strut 135 is pushed up toward the upper half 130, whereupon the split portion 133 deforms elastically until the outwardly bulging bumps 134a and 134b on the coupling strut 135 are disengaged from the recesses 137a and 137b of the mounting hole 136; as a result, the upper half 130 is decoupled from the lower half 132, whereupon the two halves can be easily taken apart.

In the magnetic tape cartridge according to the embodiment under consideration, the tip of the coupling strut 135 on the upper half 130 need not be completely inserted into the mounting hole 136 in the lower half 132 but the outwardly bulging bumps 134a and 134b may be stopped halfway down the mounting hole 136 so that the upper half 130 is temporarily fitted on the lower half 132; this offers the advantage that if required during certain operations in the production process such as mounting, dismounting and fitting-in of components, the upper half 130 can be easily separated from the lower half 132 to improve operation efficiency. As a further advantage, the upper half 130 as fitted temporarily on the lower half 132 is not liable to separate from the latter, providing a sufficiently rugged structure that the efficiency in handling of the magnetic tape cartridge on the production line is improved.

We next describe a still another embodiment of the sixth aspect of the invention. The magnetic tape cartridge having the structure shown in FIGS. 37, 38A and 38B according to the embodiment under consideration has a case body that consists of an upper half 140 and a lower half 142 to accommodate magnetic tape. This magnetic tape cartridge has a coupling strut 144 projecting from the four internal corners of the upper half 140, each coupling strut 144 having a split bulging portion 143 at its tip as shown in FIG. 38B, and a lateral edge side 145 of the upper half 140 has a fitting side 147 with a bump 146.

The lower half 142 has mounting holes 148 into which the split bulging portions 143 of the coupling struts 144 are to be inserted for fitting and the inner surface of its sidewall 149 has a recess 150 into which the bump 146 is fitted.

In order to assemble the magnetic tape cartridge having the structure shown in FIGS. 37, 38A and 38B, the following procedure is taken: after positioning or placing predetermined components in the interior, the upper half 140 is brought into registry with the lower half 142; the split bulging portions 143 at the tips of the four coupling struts 144 on the upper half 140 are inserted into the mounting holes 148; as the split bulging portion 143 at the tip of each coupling strut 144 is compressed in slidable contact with the inner peripheral surface of the mounting hole 148, the split portion 143 causes the coupling strut 144 to deform elastically in the axial direction so that it is sufficiently constricted to be fitted into the mounting hole 148. In addition, the bump 146 on the fitting side 147 continuous from the lateral edge side 145 of the upper half 140 fits into the recess 150 in the inner surface of the sidewall 149 of the lower half 142. As a result, the upper half 140 and the lower half 142 can be joined integrally to form the case body by one action without screw- or otherwise-based fastening operations.

In order to disassemble the magnetic tape cartridge, the following procedure is taken: a tool is inserted into each of the mounting holes 148 from the bottom of the lower half 142; the tip of the split bulging portion 143 of the coupling strut 144 is pressed with the inserted tool so that the coupling strut 144 is pushed up toward the upper half 140, whereupon the split bulging portion 143 deforms elastically until it is disengaged from the mounting hole 148; the upper half 140 is further lifted up to disengage the bump 146 from the recess 150; as a result, the upper half 140 is decoupled from the lower half 142, whereupon the two halves can be easily taken apart.

In the magnetic tape cartridge according to the embodiment under consideration, the tip of the coupling strut 144 on the upper half need not be completely inserted into the mounting hole 148 in the lower half 142 but the split bulging portion 143 may be stopped halfway down the mounting hole 148 so that the upper half 140 is temporarily fitted on the lower half 142; this offers the advantage that if required during certain operations in the production process such as mounting, dismounting and fitting-in of components, the upper half 140 can be easily separated from the lower half 142 to improve operation efficiency. As a further advantage, the upper half 140 as fitted temporarily on the lower half 142 is not liable to separate from the latter, providing a sufficiently rugged structure that the efficiency in handling of the magnetic tape cartridge on the production line is improved.

The foregoing description concerns the case of applying the sixth aspect of the invention to magnetic tape cartridges of the one-reel type which is shown exploded in perspective in FIG. 65. However, this is not the sole case of the sixth aspect of the invention and it can equally be applied with advantage to magnetic tape cartridges of the one-reel type having a structure of which the only the principal constituent members are shown exploded in perspective in FIG. 66, as well as to magnetic tape cartridges of the two-reel type having the structures shown in FIGS. 61 and 64.

The magnetic tape cartridge shown in FIG. 66 is of such a type that a case body built by combining the upper half 150 and the lower half 152 and fastening them securely with the screws 153 contains a tape reel 154 around which magnetic tape (not shown) is to be wound. In the foregoing embodiments of the sixth aspect of the invention, the various mechanisms of engagement described above are used instead of fastening the upper and lower halves securely with the screws 153.

Further speaking of the magnetic tape cartridge shown in FIG. 66, it has various advantages over other types of magnetic tape cartridges; first, it uses a smaller number of components; second, it can be easily disassembled into the components; third, the components can easily be put to a second use and, hence, contributes to effective recycling of constituent members; fourth, the number of components to be discarded is reduced; fifth, the individual components can be easily assembled on the production line. Therefore, in the above-described embodiments of the sixth aspect of the invention, by applying the various non-screw-based mechanisms of engagement to such a magnetic tape cartridge as above, the upper half and the lower half can be joined integrally to form the case body by one action.

As already mentioned, in order to disassemble the magnetic tape cartridges according to the embodiments of the sixth aspect of the invention, one may start the disengaging action by inserting a suitable tool into mounting holes, usually from the bottom of the lower half, and disconnect the upper half from the lower half, whereupon the two halves can be easily taken apart.

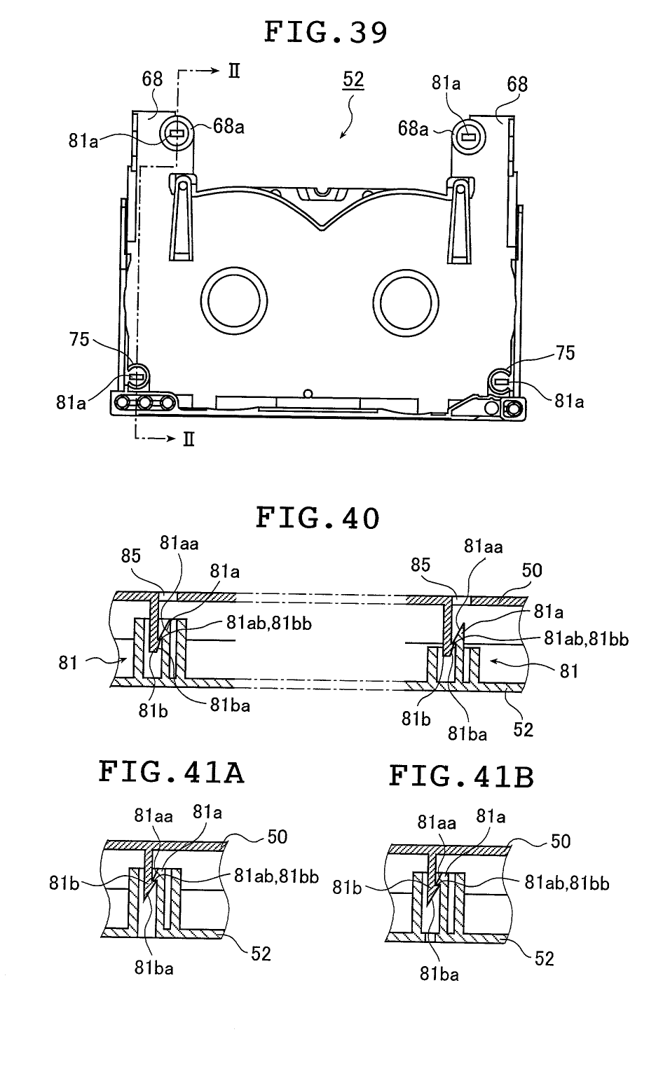

We now describe a recording media cartridge according to the seventh aspect of the invention with reference to FIGS. 39-44.

First, we discuss the case where the seventh aspect of the invention is applied to the magnetic tape cartridge of the two-reel type which was already described with reference to FIG. 61 and then we will discuss the case of applying the same aspect to the magnetic tape cartridge of the two-reel type which was also described with reference to FIG. 64.

FIG. 39 is a plan view of a lower half for a magnetic tape cassette according to an embodiment of the seventh aspect of the invention; FIG. 40 is section taken along the broken line II-II in FIG. 39 and it shows the lower half of FIG. 39 with an upper half in registry. On the pages that follow, the overall structure of the two-reel type magnetic tape cartridge already described with reference to FIG. 61 is omitted and only the essential points are described.

In FIGS. 39 and 40, numeral 50 designates an upper half, 52 a lower half, 68 an extension, 68a a tape guide, and 75 a screw boss; numeral 81 designates a snap mechanism section which is a characterizing structural part of the embodiment under consideration and it comprises an engaging pawl 81a, an engaging member 81b, a disengagement hole 85, etc.

The snap mechanism section 81 in the embodiment under consideration uses the interior of the tape guide 68a on the extension 68 as the first installation area (two of such sections are installed) and uses the interior of the screw boss 75 on the other side as the second installation area. The snap mechanism sections 81 provided in the respective installation areas have slightly different sizes for the engaging pawl 81a and the engaging member 81b but they share essentially the same structure.

Thus, the engaging pawls 81a provided on the top surface of the lower half 52 and the engaging members 81b provided on the underside of the upper half 50 are so adapted that when the upper half 50 is placed on top of the lower half 52 in registry, they engage with each other to thereby join the upper half 50 and the lower half 52 in four areas.

More specifically, the engaging pawl 81a is a generally prismatic member erected on the top surface of the lower half 52 and its apical portion forms a tapered face 81aa for guiding the engaging member 81b on the upper half 50 which is to be inserted from above. The lower end of the tapered face 81aa forms a hook-shaped engaging portion 81ab. The shape and position of the engaging member 81b on the upper half 50 are generally symmetrical with those of the engaging pawl 81a. The lower end portion of the engaging member 81b forms a tapered face 81ba that will contact the tapered face 81aa of the engaging pawl 81a on the lower half 52 upon its insertion from above and the terminal end (top end in FIG. 40) of the tapered face 81ba forms a hook-shaped engaging portion 81bb.

When the upper half 50 is combined with the lower half 52, the engaging member 81b on the upper half 50 is brought into engagement with the engaging pawl 81a on the lower half 52, first by contact of their tapered faces 81aa and 81ba, then by contact of their hook-shaped engaging portions 81ab and 81bb, eventually causing the upper half 50 to be joined with the lower half 52.

For each snap mechanism section 81, the disengagement hole 85 is provided in the upper half 50 and by manipulation through this hole, the engaging pawl 81a is deformed in such a direction that it is brought out of engagement with the engaging member 81b. In order to disassemble the magnetic tape cassette, a tool such as a screw driver is pushed into the disengagement hole 85 and the engaging pawl 81a is caused to flex, thereby attaining the intended object, i.e. canceling the engagement between the engaging pawl 81a and the engaging member 81b.

In this embodiment, the snap mechanism section 81 is provided in the positions of the tape guides 68a which are important to systems using the magnetic tape cassette, so the magnetic tape cassette according to this embodiment has the advantage of maintaining consistent system operation.

FIGS. 41A and 41B show another examples of the engagement hole 85. In each of the examples, the disengagement hole 85 is made in the lower half 52 under the condition that the layout of the engaging pawl 81a and the engaging member 81b provided on the lower and upper halves is reversed to that in the embodiment shown in FIG. 40. FIG. 41A shows the case where no undercut is formed in the disengagement hole 85 and FIG. 41B shows the case where an undercut is formed (particularly for the hook-shaped engaging portion 81ab of the engaging pawl 81a on the lower half 52).

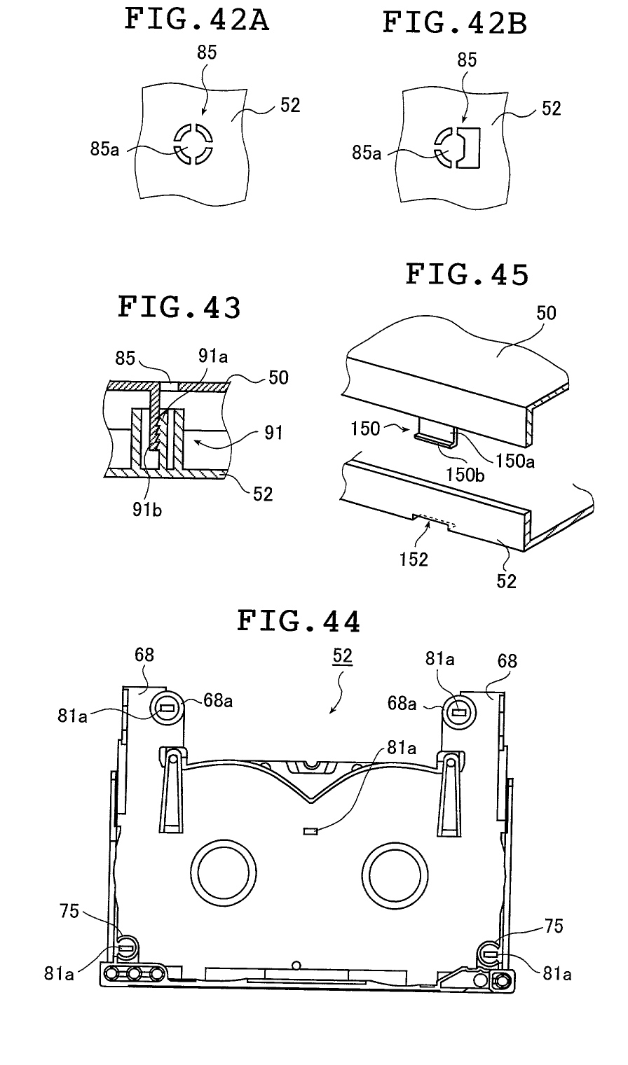

Each example of the disengagement hole described above may be modified as shown in FIGS. 42A and 42B. To be specific, the disengagement hole 85 is fitted with a disengagement hole cover member 85a of an easy-to-break structure and this allows for the recording of any act of disassembling the magnetic tape cassette, in other words, recording the fact that the magnetic tape cassette in question has been disassembled once.

FIG. 42A shows a common example of the disengagement hole cover member 85a. The example shown in FIG. 42B is connected to the lower half 52 only in three directions, with the area of the other direction being left wide open. This is a design to simplify the formation of an undercut in the molding of the engaging pawl 81a or the engaging member 81b and the open gap itself is too small to permit the passage of a tool for disassembling the magnetic tape cassette.

An advantage of such modification as above is that if a trouble occurs to a shipped product, the manufacturer can determine whether the cause is inappropriate handling, for example, accidental disassembling of the magnetic tape cassette and unauthorized tampering of its interior.

FIG. 43 is a sectional view showing the engaging mechanism in a magnetic tape cassette according to another embodiment of the seventh aspect of the invention (and which corresponds to FIGS. 40, 41A and 41B). In this embodiment, a ratchet mechanism section 91 is used instead of the snap mechanism section 81. The ratchet mechanism section 91 consists of ratchet pawls 91a and ratchet pawls 91b. The basic action of this ratchet mechanism section 91 is essentially the same as that of the snap mechanism section 81 and need not be described in detail.

The magnetic tape cassette according to this embodiment achieves as good results as can be attained by the previous embodiments of the seventh aspect of the invention. Needless to say, the disengagement hole cover members used in the examples shown in FIGS. 42A and 42B can also be applied to the example shown in FIG. 43.

The foregoing two embodiments refer to the case where the engaging mechanism (snap mechanism or ratchet mechanism) consisting of a pawl and a corresponding engaging member is provided in four areas including the areas of the tape guides 68a. This design is effective for maintaining consistent system operation as by stabilizing the run of magnetic tape. In the following, we describe examples of combining the engaging mechanism with other functional areas.

In one case, one out of a plurality of engaging mechanisms each consisting of the pawl and the corresponding engaging member may be provided in the neighborhood of the brake members in the magnetic tape cartridge (for example, in the position in the center of the upper and lower halves indicated by numeral 81a in FIG. 44); with this design, the brake members are held sufficiently stable in a vertical direction between the upper and lower halves that they can operate with greater consistency.

Although not shown in FIG. 44, at least the engaging members 81b that correspond to the engaging pawls 81a are provided on the upper half in the positions that correspond to said engaging pawls 81a. Preferably, disengagement holes and backup members for supporting the disengaging operation (which may be so shaped as to surround the engaging members 81b) are provided as aids for canceling the action of the engaging mechanism.

If the seventh aspect of the invention is to be applied to a magnetic tape cartridge of the two-reel type which has the structure shown in FIG. 64, an engaging mechanism of the aforementioned structure consisting of a pawl and a corresponding engaging member to be provided on the upper and lower halves is preferably provided in the neighborhood of the lid locking portion or the anti-erasure plug.

In the magnetic tape cassette having this structure, the tape reel locking member 37 and the anti-erasure plug 70 are adapted to be slidable. Therefore, by providing the already described upper and lower half engaging mechanism (snap mechanism or ratchet mechanism) in the neighborhood of those sliding mechanisms, one can ensure positive engagement of the upper and lower halves.

For the method of molding members having an undercut as exemplified by the engaging pawl 81a and the engaging member 81b, reference may be had to “Textbook for Correspondence Course—Mold Design for Injection Molding” published by I.P.C. Those members can be easily shaped with a combination of slide core equipped molds of the types described in the Textbook. This molding method is not the sole approach that can be taken by the invention and various other methods may of course be employed. Similar molding methods can also be applied with advantage to the shaping of the ratchet mechanism used in the second embodiment.

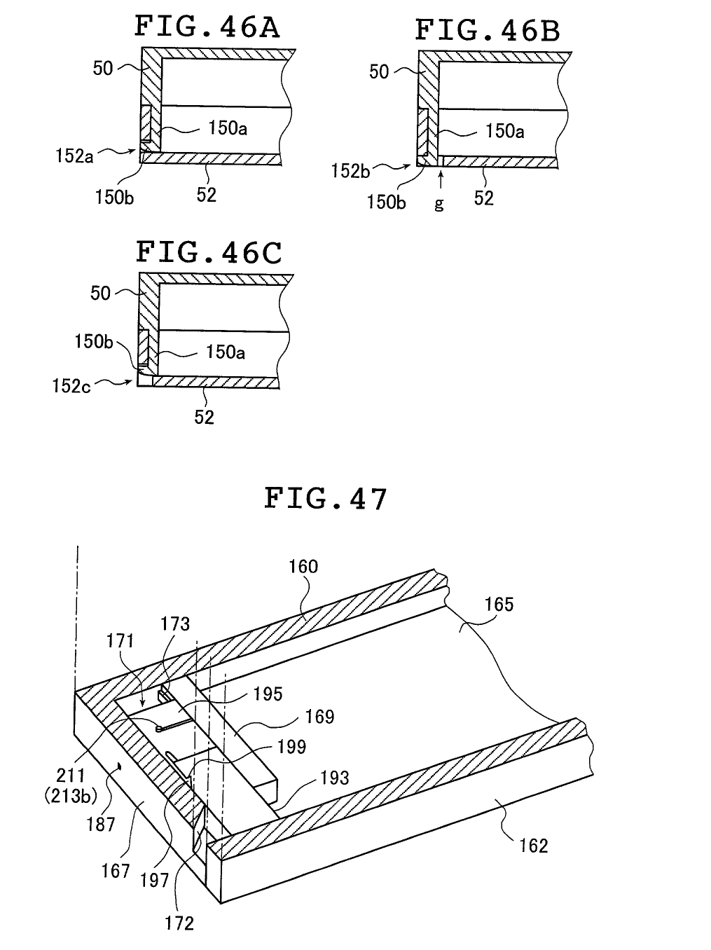

We next describe a recording media cartridge according to the eighth aspect of the invention with reference to FIGS. 45-46C. The following description mainly concerns the case of applying the eighth aspect of the invention to a magnetic tape cartridge of the two-reel type already described with reference to FIG. 61.

FIG. 45 is a partial enlarged perspective view showing how an upper half is combined with a lower half to make the magnetic tape cassette according to an embodiment of the eighth aspect of the invention. Again, the general structure of the magnetic tape cassette already described with reference to FIGS. 61 and 62 is omitted and only the essential points will be described.

In FIG. 45, numerals 50 and 52 designate the upper half and the lower half, respectively, for the magnetic tape cassette according to the embodiment under consideration. In FIG. 45, it is shown that an engaging member 150 on the upper half 50 is fitted into an engaging portion 152 on the lower half 52, whereby the two halves are joined together.

The engaging member 150 on the upper half 50 consists of two portions, the first being a portion 150a which is formed by extending a part of a sidewall of the upper half 50 downward (toward the lower half 52) and the second being a bent engaging lip 150b that is brought into engagement with the engaging portion 152 on the lower half 52. The engaging member 150 is a thin sheet that is adapted to have an appropriate degree of flexibility in a plane normal to the paper on which FIG. 45 is drawn.

FIGS. 46A-46C show three modes of the joint between the upper half 50 and the lower half 52. FIG. 46A shows the case where no cutout is made in that part of the lower half 52 (its bottom) which is to be contacted by the engaging lip 150b of the engaging member 150 on the upper half 50; FIG. 46B shows the case where a large cutout is made in the bottom of the lower half 52; and FIG. 46C shows the case where a cutout is made in the bottom of the lower half 52 to a depth nearly approaching the center of the engaging member 150 on the upper half 50.

If a large cutout is made in the bottom of the lower half 52 as shown in FIG. 46B, the engaging member 150 inserted from above can be easily brought into engagement with the engaging portion 152b on a sidewall of the lower half 52; however, a gap (see an arrow g) will form between the tip portion of the engaging member 150 in engagement with the engaging portion 152b and the bottom of the lower half 52.

On the other hand, if no cutout is made in the bottom of the lower half 52 as shown in FIG. 46A, not only is it easy for the inserted engaging member 150 to be brought into engagement with the engaging portion 152a on a sidewall of the lower half 52 but also the tip portion of the engaging member 150 in engagement with the engaging portion 152a will have positive contact with the bottom of the lower half 52, thus presenting no problem with the prevention of dust from entering the space between the upper and lower halves.

The design shown in FIG. 46A, however, has the problem of requiring a complex mold design in order to shape the engaging portion 152a on a sidewall of the lower half 52 with which the engaging member 150 will come into engagement. Thus, the choice between the design shown in FIG. 46A and the design shown in FIG. 46B depends on which of the two factors should be given priority, dust prevention or ease of molding.

The design shown in FIG. 46C has been proposed as a compromise; the engaging portion 152c on a sidewall of the lower half 52 with which the engaging member 150 will come into engagement can be molded without using any special die containing a slide core or the like and still a reasonable degree of contact is ensured between the engaging member 150 and the bottom of the lower half 52.

Hence, it can be said that the design shown in FIG. 46C realizes a method of joining the upper and lower halves of the magnetic tape cassette while satisfying both requirements for efficient molding and effective dust prevention in a balanced way. From a practical viewpoint, the design shown in FIG. 46C is the easiest to adopt.

We now describe FIGS. 46A-46C in greater detail. The upper half 50 having the flexible engaging member 150 is common to the three figures, so the following description only concerns the engaging portions 152a-152c provided on the lower half 52.

In the magnetic tape cassette of the design shown in FIG. 46A, the engaging member 150 formed on the upper half 50 is inserted and flexes as its tip portion (engaging lip 150b) goes along the inner surface of a sidewall of the lower half 52 until it contacts the bottom of the lower half 52, whereupon it comes into engagement with the engaging portion 152a. The engaging portion 152a (cutout) is provided only on a sidewall of the lower half 52 and, as already mentioned, in order that the lower half 52 having such a cutout is produced by molding, it is necessary to use a mold designed in consideration of the presence of an overhang.

Speaking of the magnetic tape cassette having the design shown in FIG. 46B, the engaging member 150 formed on the upper half 50 is inserted and flexes as its tip portion (engaging lip 150b) goes along the inner surface of a sidewall of the lower half 52 and this is the same as with the magnetic tape cassette of the design shown in FIG. 46A; the difference is that the engaging lip 150b is engaged with the engaging portion 152b without contact with the bottom of the lower half 52. As is clear from FIG. 46B, the engaging portion 152b (cutout) is formed to span the sidewall to the bottom of the lower half 52 and no special die is necessary to produce the lower half 52 having such engaging portion by molding.

In the magnetic tape cassette of the design shown in FIG. 46C, the engaging member 150 formed on the upper half 50 is inserted and flexes as its tip portion (engaging lip 150b) goes along the inner surface of a sidewall of the lower half 52 until it lightly contacts the bottom of the lower half 52, whereupon it comes into engagement with the engaging portion 152c (cutout). The action involved is the same as in the case of the design shown in FIG. 46A.

In the design shown in FIG. 46C, the engaging portion 152c (cutout) occupies a wide area spanning the sidewall to the bottom of the lower half 52 and it is preferred that the position (and size) of the cutout portion in the sidewall of the lower half 52 are the same as in the design shown in FIG. 46A whereas the cutout portion in the bottom of the lower half 52 reaches near the center (defined in the lateral direction in the figure) of the engaging member 150 inserted. The cutout portion in the bottom of the lower half 52 is effective for simplifying the mold design.

Examples of such additional engaging mechanisms (for reinforcing the engagement) as described above may include the mechanism using an engaging member that can be fitted over the upper and lower halves as already shown in FIG. 6. The U-shaped engaging member indicated by numeral 30 in FIG. 6 is to be pressed into the engaging member insertion grooves 50e and 52e provided in the outer surfaces of the upper and lower halves. The U-shaped engaging member 30 may be applied additionally after the engagement of the upper and lower halves is realized by means of the engaging mechanism according to the embodiment described above, which consists of the engaging member 150 and the cutout portion 152.

The use of such additional engaging mechanisms (for reinforcing the engagement) has the obvious advantage of providing a more positive and stronger engagement of the upper and lower halves. In addition, the assembled upper and lower halves are less sensitive to the deforming effect of creep and other stresses that develop in the constituent material of the halves as mentioned before.

On the pages that follow, we describe a recording media cartridge according to the ninth aspect of the invention with reference to FIGS. 47-53. The following description mainly concerns the case of applying the ninth aspect of the invention to a magnetic tape cartridge of the two-reel type already described with reference to FIG. 64 but this is not the sole application of the ninth aspect of the invention. Again, the general structure of the magnetic tape cassette already described with reference to FIGS. 61 and 62 is omitted and only the essential points will be described.

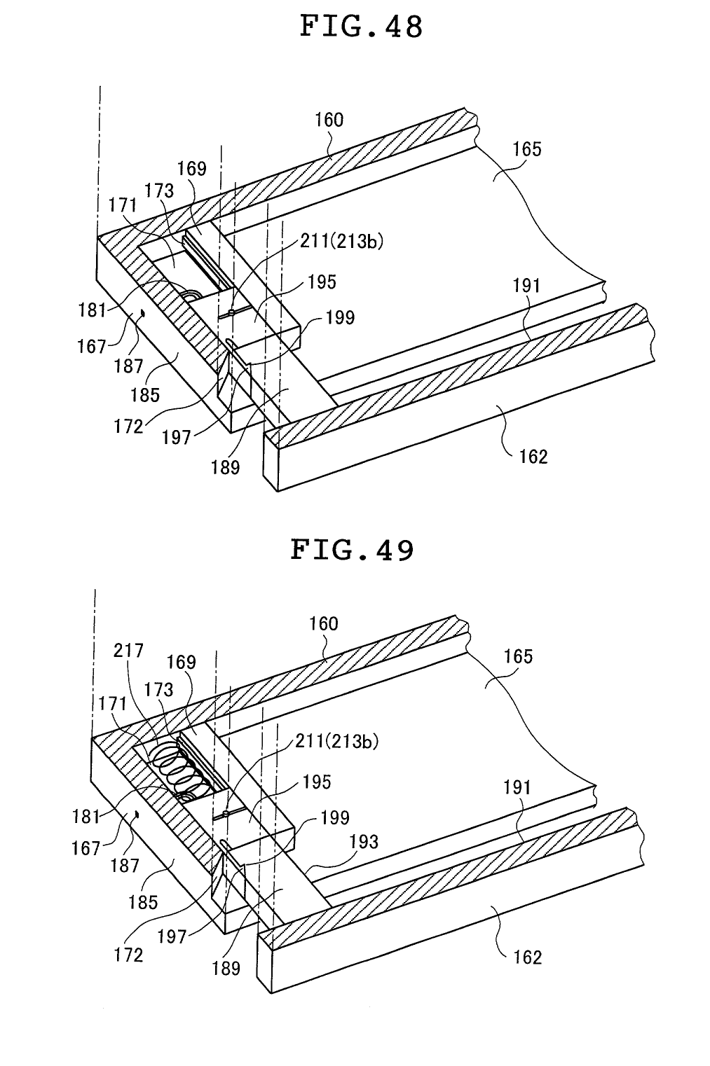

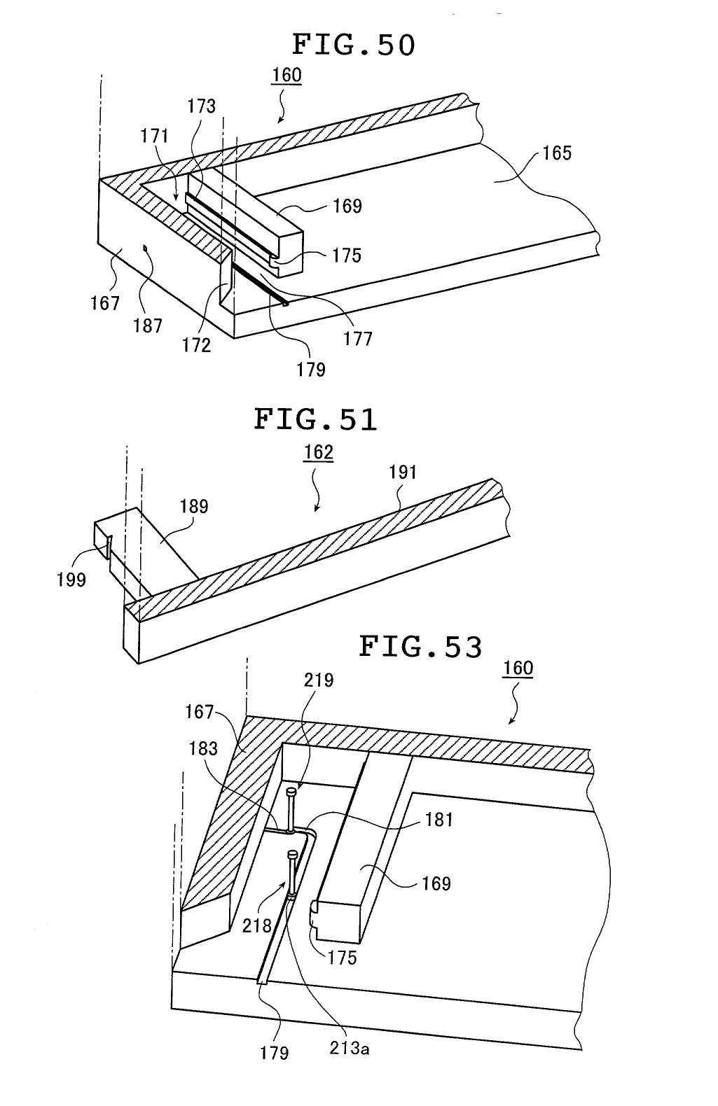

FIG. 47 shows a magnetic tape cassette in a joined state and FIG. 48 shows it in a disassembled state. An upper half 160 is joined with a lower half 162 to make a case body. As shown in FIG. 50, the upper half 160 has a guide arm portion 169 projecting from a sidewall 165 in a direction parallel to another sidewall 167 that crosses the sidewall 165 at right angles. A fitting groove portion 171 is formed between the guide arm portion 169 and the sidewall 167. The lower part of the sidewall 167 has a tapered portion 172 that is open upward at an angle with the fitting groove portion 171.

The guide arm portion 169 has a linear guide ridge 173 formed on the lateral side facing the fitting groove portion 171 and the guide ridge 173 has an engaging pawl end 175 at its end closer to the lower half 162.

A linear introduction groove 179 is cut in the inner surface 177 of a sidewall of the upper half 160 within the area of the fitting groove portion 171 to extend from the lower half 162 side toward the upper half 160 side. The linear introduction groove 179 communicates with a continuous upwardly arched engagement groove 181 to be described later (see FIG. 53) and the engagement groove 181 in turn communicates with a disengagement groove 183 cut to extend toward the sidewall 167 of the upper half 160. The disengagement groove 183 communicates with a disengagement hole 187 that extends through the sidewall 167 of the upper half 160 to be open in its outer lateral surface 185.

As shown in FIG. 51, the lower half 162 has a fit insertion member 189 that is erected on the bottom 191 and which is slidably fit inserted into said fitting groove portion 171. The fit insertion member 189 has a linear fitting groove (not shown) in a lateral surface 193 into which the linear guide ridge 173 on said guide arm portion 169 is fitted; in a lateral area of the fit insertion member 189, there is formed a meshing recess 199 that meshes with a meshing pawl portion 197 of a sliding member 195 to be described later.

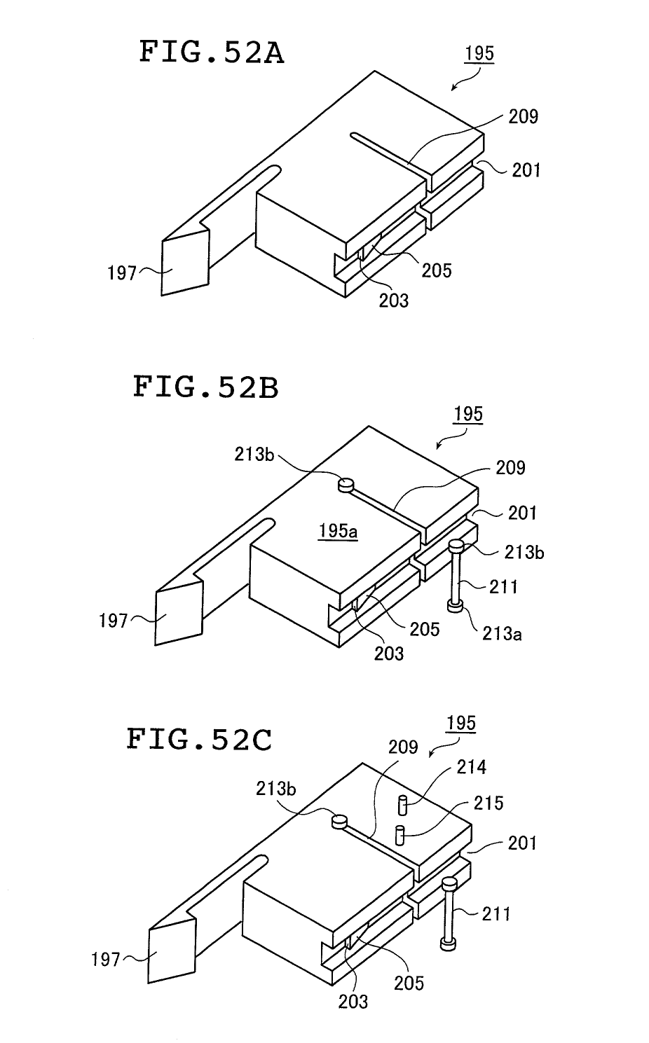

As shown in FIG. 52A, the sliding member 195 to be fitted in said fitting groove portion 171 has a slide groove 201 into which the linear guide ridge 173 on said guide arm portion 169 is to be slidably fitted and the inner bottom surface of the slide groove 201 has a projecting engaging portion 205 that has an engaging face 203 which comes into engagement with the engaging pawl end 175 provided on the linear guide ridge 173 at its end closer to the lower half.

The sliding member 195 has the meshing finger portion 197 that meshes with the meshing recess 199 provided in a lateral area of the fit insertion member 189. A linear loose insertion groove 209 is cut through the body 195a of the sliding member 195 to extend from the lateral side having the slide groove 201 toward the other lateral side. As shown in FIG. 52B, a guide pin 211 is fitted loosely into the linear loose insertion groove 209. As shown in FIG. 53, the head 213a at one end of the guide pin 211 is slidably fitted in the linear introduction groove 179, the linear engagement groove 181 and the disengagement groove 183 and the head 213b at the other end projects from a surface of the body 195a of the sliding member 195 (see FIG. 52B).

In the magnetic tape cassette under consideration, the guide pin 211 is loosely fitted in the linear loose insertion groove 209 in the sliding member 195 such that the head 213a at an end of the guide pin 211 is fitted in the linear introduction groove 179 in the fitting groove portion 171; in addition, the linear guide ridge 173 on the guide arm portion 169 is fitted in the slide groove 201 in the sliding member 195 such that the latter can slide vertically through the fitting groove portion 171; the head 213b at the other end of the guide pin 211 projects from the obverse side of the body 195a of the sliding member 195. The sliding member 195 is adapted to reciprocate between two positions, one being the position (bottommost) where the engaging face 203 of the engaging portion 205 is in engagement with the engaging pawl end 175 of the linear guide ridge 173 and the other being the position (topmost) where the guide pin 211 passes the arched engagement groove 181 to become engaged in the disengagement groove 183.

The meshing pawl portion 197 of the sliding member 195 is allowed to mesh with the meshing recess 199 in the fit insertion member 189 on the lower half 162 and, in addition, the linear guide ridge 173 on the guide arm portion 169 is fitted in the linear fitting groove in a lateral surface of the fit insertion member 189. Thereafter, the upper half 160 is pushed down or the lower half 162 is pushed up, whereby the fit insertion member 189 on the lower half 162 is fitted into the fitting groove portion 171 as the sliding member 195 slides upward. As the fit insertion member 189 is fitted into the fitting groove portion 171, the guide pin 211 is loosely fitted in the linear loose insertion groove 209 in the sliding member 195 as shown in FIG. 53. Starting from the position indicated by reference numeral 218 in FIG. 53, the guide pin 211 is guided along the linear introduction groove 179 to slide upward, makes a turn at the bent portion of the engagement groove 181 and further proceeds until it becomes engaged in the disengagement groove 183 (in the position indicated by reference numeral 219). As a result, the upper half 160 is tightly joined with the lower half 162 to make the case body shown in FIG. 47.

As shown in FIG. 52C, an urging rib 214 and a regulating rib 215 may be provided to project from the surface of the body 195a of the sliding member 195 in an area above the linear loose insertion groove 209; if the urging rib 214 is loaded with a torsion coil spring one end of which is made to contact the regulating rib 215 while the other end is allowed to contact the head 213b at the other end of the guide pin 211 which has been guided to slide into engagement in the disengagement groove 183, the guide pin 211 is urged toward the sidewall 167 of the upper half 160, assuring a positive engagement of the guide pin 211 in the disengagement groove 183 and proving an effective way to provide a strong enough joint between the upper half 160 and the lower half 162. As shown in FIG. 49, a coil spring 217 may additionally be provided within the fitting groove portion 171 between the top of the sliding member 195 and a sidewall of the upper half 160 so that the coil spring 217 urges the sliding member 195 toward the lower half 162; this offers the advantage that the guide pin 211 in the disengagement groove 183 is urged toward the lower half 162, assuring a more positive engagement of the guide pint 211 in the disengagement groove 183.

In order to disassemble the magnetic tape cassette under consideration, the following procedure is taken: a tool such as a needle-like member is inserted into the disengagement groove 183 in the outer lateral surface 185 of the sidewall 167 of the upper half 160 and the head 213a at one end of the guide pin 211 in engagement with the disengagement groove 183 is pushed toward the engagement groove 181 while at the same time the lower half 162 is pulled down so that the sliding member 195 slides downward; as a result, the guide pin 211 passes the engagement groove 181 and is guided along the linear introduction groove 179 so that the lower half 162 can be further lowered down as shown in FIG. 47. Consequently, the upper half 160 can be easily decoupled from the lower half 162 to disassemble the case body. As FIG. 48 shows, the meshing finger portion 197 of the sliding member 195 is capable of bending in the direction perpendicular to that of cartridge height (or swinging) in the tapered portion 172 within the limits of its elasticity and this is effective in providing a method by which the meshing pawl portion 197 can be easily brought out of engagement with the meshing recess 199.

If, as shown in FIG. 49, the coil spring 217 is additionally provided within the fitting groove portion 171 so as to urge the sliding member 195 toward the lower half 162, the linear introduction groove 179 of the sliding member 195 can be easily pushed down toward the lower half 162, the linear introduction groove 179 of the sliding member 195 can be easily pushed down toward the lower half 162; this offers the advantage of providing ease in disengaging the upper half 160 from the lower half 162.

In the embodiment described above, the screws conventionally used to join the upper half 160 and the lower half 162 are replaced by the sliding member 195 and yet one can ensure comparable levels of strength and shape stability to those obtained by joining the two halves with the screws. What is more, the change in the method of joining the upper and lower halves will not cause any adverse effects on the basic performance of the assembled magnetic tape cassette.

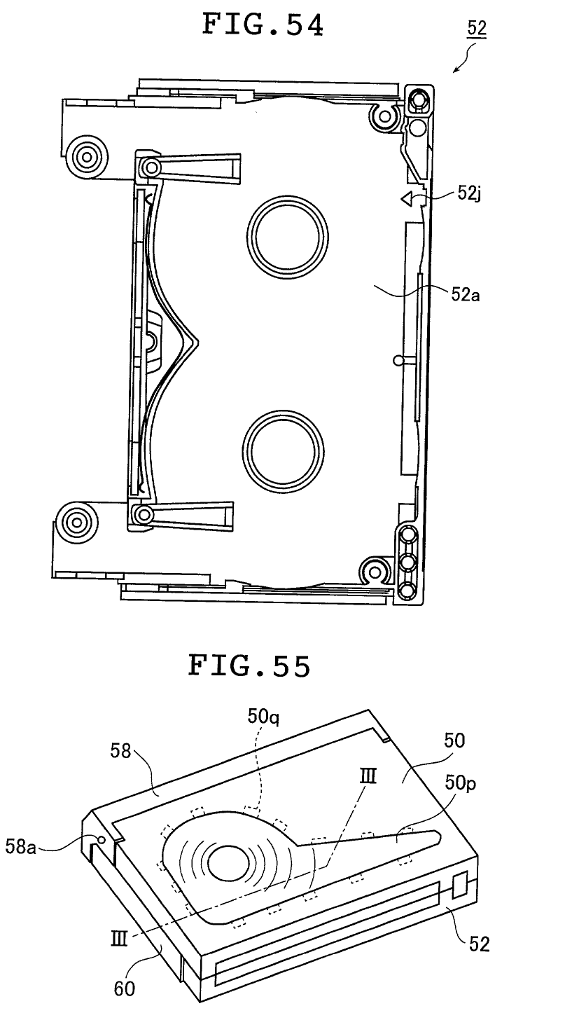

We next describe a recording media cartridge according to the tenth aspect of the invention with reference to FIG. 54.

In the magnetic tape cassette according to the tenth aspect of the invention, the constituent parts or members are colored differently according to the resin materials of which they are made. The term “colored” or “coloring” as used in connection with the tenth aspect of the invention not only means that the constituent parts or members are entirely processed to have colors that designate the resin materials of which they are made; the term also means that the constituent parts or members are partly labelled with marks containing geometric figures such as “∘”, “□” and “Δ” that have different colors than the background. This coloring helps the person who is disassembling the recording media cartridge to easily differentiate the resin materials of which the parts or members are made and assort them accordingly. Take, for example, a magnetic tape cassette of the two-reel type. If the upper half, the lower half, the slider, the brake member and other components are processed to have different colors according to the resin materials of which they are made, those resin materials can conveniently be assorted by reference to the colors.

If necessary, the resin materials used may be expressly named in the operating manual of the magnetic tape cassette according to the colors applied and this provides ease in assorting the resin materials when the magnetic tape cassette is disassembled and discarded.

In the tenth aspect of the invention, parts or components may be colored by any methods including painting, addition of pigments to the resin materials of which they are made, as well as printing of marks, stamping of them and attaching of labels. A suitable method should be selected as appropriate for the shape of the parts or components, their size, the resin materials used, etc.

If desired, application of colors and presentation of marks may both be effected in accordance with the resin materials of which the constituent parts or members are made. This is an effective way to assure positive differentiation between the resin materials to be assorted.

Presentation of marks can be effected by providing specified marks in selected areas by various methods including printing, stamping and attaching of labeling seals. The marks should preferably be explained and keyed in the operating manual.

In the recording media cartridge according to the tenth aspect of the invention, the colors used in accordance with the resin materials of which the constituent parts or members of the cartridge are made may be explained on the inner surface of the case body. This eliminates the need to explain the colors in the operating manual. Even if the operating manual is lost, the colors or marks provide a positive way to inform the user, scrapper, etc. of the resin materials used.

The need to know the names of the resin materials used arises at the time of discarding the recording media cartridge and hence presupposes disassembling of it. Therefore, once the cartridge is disassembled, the user or scrapper may simply look at the inner surface of the case body to know what resin materials are used in the respective parts or members and assort them in an appropriate way.

To produce a case body which has marks presented on it, a die for injection molding of the case body is provided with a cavity for imparting the desired presentation (e.g. a symbol, a letter or a sentence) and injection molding is performed with this die, producing a case body that has been stamped with the presentation.

The site where presentations are to be imparted can be chosen from various positions including those which do not interfere with the action of any other constituent parts or members of the recording media cartridge.

The magnetic tape cassette according to the tenth aspect of the invention is described below more specifically by taking the lower half shown in FIG. 54 as an example. Again, the overall structure of the magnetic tape cassette already described with reference to FIGS. 61 and 62 is omitted and only the essential points will be described.

The lower half generally indicated by numeral 52 in FIG. 54 may typically be colored in black. A symbol 52j, for example, “Δ” in white, is presented on the inner surface 52a of the lower half 52 to inform the user or scrapper that it is made of a specified resin.

As a result, the person who is disassembling the magnetic tape cassette can easily recognize that the lower half 52 is formed of the specified resin and this assures appropriate assorted collection or discarding of the lower half 52.

We next describe a shaped resin article according to the eleventh aspect of the invention with reference to FIGS. 55-60.

On the pages that follow, the shaped resin article according to the eleventh aspect of the invention is described by referring to a magnetic tape cassette that is so adapted that the window through which to check the residual amount of magnetic tape can be easily separated from the case body.

FIG. 55 shows a magnetic tape cassette according to an embodiment of the eleventh aspect of the invention.

As shown in FIG. 55, the magnetic tape cassette according to this embodiment comprises an upper half 50 and a lower half 52 that combine to make a case body (cassette case). A slider 60 is fitted on the underside of the lower half 52 and a front cover (lid) 58 is provided on the front face of the cassette (the side remote from the viewer of FIG. 55). The slider 60 is capable of sliding back and forth along the underside of the lower half 52 and when the cassette is not in service, the slider 60 closes the open area along the underside of the cassette case so that no dust will get in. The lid 58 is pivotably mounted on a shaft 58a through the upper half 50 such that the front face of the cassette can be opened or closed as required.

The case body of the magnetic tape cassette contains magnetic tape 56 as wound around a pair of take-up hubs 54a and 54b. The upper half 50 has a transparent window 50b through which the user can check the residual amount of tape as after the magnetic tape cassette is taken out of the record/reproduce apparatus (not shown).

The other parts of the magnetic tape cassette according to the embodiment under consideration have generally the same construction as shown in FIG. 61 and, hence, are not described in detail.

The magnetic tape cassette according to the embodiment under consideration is adapted to be such that the window 50b can be easily removed from the case body (the upper half 50) as the cassette is disassembled.

This point is further discussed below.

The window 50b is molded of a material that is compatible with the upper half 50 (or case body), namely, a material having a compatibilization parameter nearly equal to that of the upper half 50 and which is adhesive to it. In the embodiment under consideration, the window 50b is shaped by core-back two-color molding (two-layer molding) using the same die as for the upper half 50, with care being taken that the window 50b basically adheres to the upper half 50 only in part of the periphery of the window 50b.

Specifically, as shown in FIG. 55, the window 50b has a plurality of projecting adhering portions 50q on the perimeter and, in principle, it is only in these adhering portions 50q that the window 50b adheres to the (inner surface of the) upper half 50.

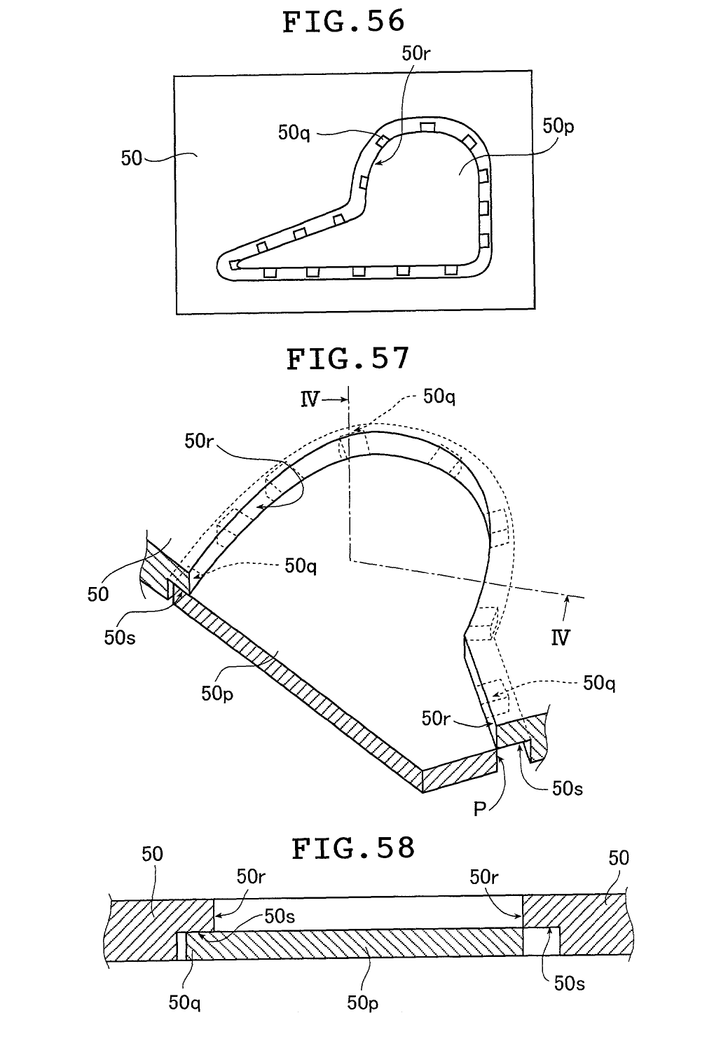

FIG. 56 shows how the upper half 50 adheres to the window 50b. Being a plan view of the back side of the upper half 50 having the window 50b (i.e., the inner surface of the magnetic tape cassette), FIG. 56 particularly shows how the window 50b adheres to the upper half 50, with the various other members of the upper half 50 being omitted.

As shown, the upper half 50 has an opening 50r conformal to the shape of the window to be provided thereon and the adhering portions 50q projecting from the perimeter of the window 50b are brought into contact with the edge of the opening 50r, thereby providing the window 50b in position.

The upper half 50 and the window 50b of the magnetic tape cassette shown in FIG. 55 are cut on line III-III in FIG. 55 and taken in perspective in FIG. 57 to show enlarged the adhesion between the window 50b and the upper half 50.

As is clear from FIG. 57, the edge of the opening 50r in the upper half 50 in which the window is to be mounted is such that a step 50s is formed in the inner surface of the cassette case and that the adhering portions 50q of the window 50b adhere to the step 50s from below. As for those areas of the window 50b which do not have the adhering portions 50q, the edge of the step 50s around the opening 50r in the upper half 50 is adapted to contact the edge of the window 50b at points (on a line) as indicated by reference character P in FIG. 57.

FIG. 58 is section taken along the line IV-IV in FIG. 57. As FIG. 58 shows, the adhering portion 50q of the window 50b is brought from below into contact with the step 50s at the edge of the window opening 50r in the upper half 50. As shown in the right half of FIG. 57, the edge of the window 50b makes point contact with the edge of the window opening 50r in the upper half 50 in those areas of the window 50b where the adhering portion 50q is absent.

The method of molding the upper half 50 and the window 50b is described below.

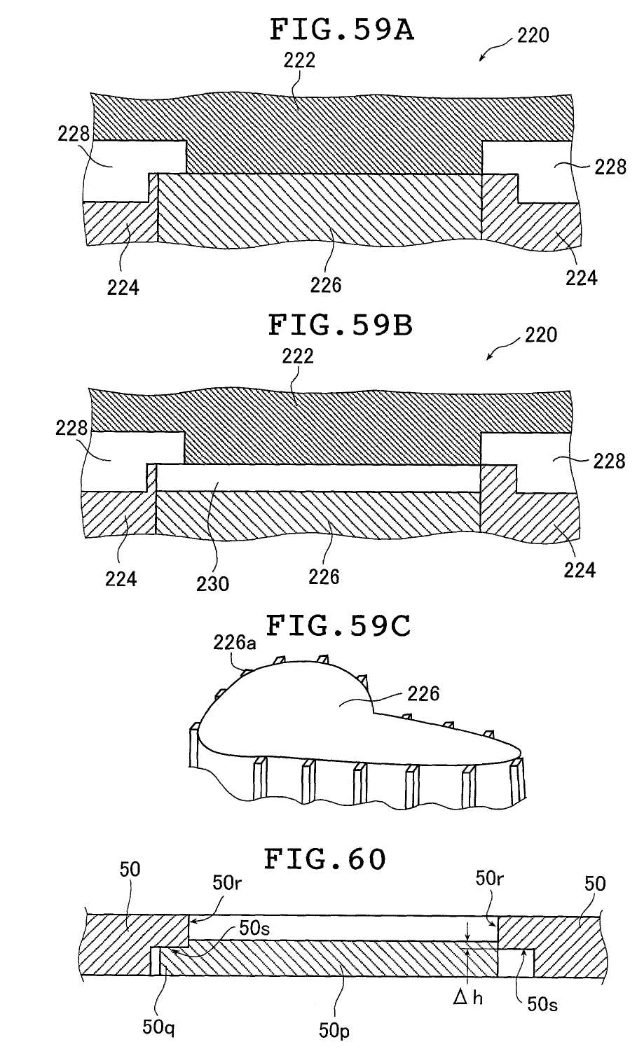

FIGS. 59 are diagrammatic sections of a die used to mold the upper half 50 and the window 50b in the embodiment under consideration. As shown in FIG. 59A, the die generally indicated by numeral 220 and used to mold the upper half 50 and the window 50b in the embodiment under consideration is for core-back two-color molding and consists essentially of an upper die 222, a lower die 224 and a movable core 226. The upper die 222, the lower die 224 and the movable core 226 define a space 228, into which a molten resin (e.g. an ABS resin) is injected to shape the upper half 50.

Subsequently, as shown in FIG. 59B, the movable core 226 is slid down by a distance corresponding to the thickness of the window 50b; into the resulting space 230, a transparent resin material compatible with the resin used to mold the upper half 50 (i.e., a material having a nearly equal compatibilization parameter to the material the upper half 50 is made of and which is adhesive to it) is injected to mold the window 50b.

An outline for the shape of the movable core 226 used to mold the window 50b is shown in perspective in FIG. 59C. As shown in FIG. 59C, the movable core 226 for molding the window 50b has projections 226a on its perimeter for shaping the adhering portions 50q of the window 50b.

In the embodiment under consideration, the upper half 50 and the window 50b are shaped by two-color molding and, hence, the whole molding operation can be effected in one step. In addition, the upper half 50 and the window 50b are molded of mutually compatible materials, so they can be caused to adhere to each other by simply molding them in two layers and there is no need to adopt a separate step for bonding them together. Further in addition, the window 50b adheres to the upper half 50 only at the adhering portions 50q projecting from the perimeter of the window 50b; hence, the peel strength is small enough to ensure easy detachment of the window 50b from the upper half 50 and selective collection of parts can easily be achieved, thus increasing the volume of parts that can be collected in separate form. The peel strength can be made even smaller by further decreasing the total area of the adhering portions 50q.

There is no need to provide an overlap between the upper half 50 and the window 50b in the direction of their depth. This is because in the embodiment under consideration which adopts a core-back two-color molding technique, the edge of the window 50b makes point contact with the edge of the upper half 50 in all areas except in the adhering portions 50q and this substantial absence of a gap assures effective prevention of dust from getting into the cassette case.

In order to provide more effective dust prevention, it is preferred that the upper half 50 and the window 50b overlap by a very small amount in the direction of their thickness. More specifically, the edge of the opening 50r in the upper half 50 is adapted to overlap the window 50b in the direction of thickness by a very small amount of Ah as shown in FIG. 60. The overlap Δh is desirably no more than 0.4 mm or one fifth of the thickness of the upper half 50. This amount of overlap is sufficient to provide positive prevention of dust and dirt from getting into the cassette case. In this case, the window 50b will adhere to the upper half 50 on the entire perimeter but the overlap Δh is so small that that it will not present any problem when the window 50b is detached from the upper half 50 and collected.

In the embodiment described above, the window 50b and the upper half 50 are molded in two colors using the same die but if desired, they may be molded on two separate dies. In this alternative case, too, it is preferred that the upper half 50 and the window 50b are molded of mutually compatible materials to have the same geometry as in the embodiment described above. Needless to say, the separately molded window 50b must later be welded (in the adhering portions) to the upper half 50.

While the magnetic tape cartridge and shaped resin article of the invention have been described above in detail with reference to various embodiments of the respective aspects of the invention, it should be noted that those embodiments are for illustrative purposes only and are by no means intended to limit the invention. Various improvements and modifications are of course possible without departing from the scope and spirit of the invention.

For example, in addition to the various types of magnetic tape cartridges (magnetic tape cassettes) described above in connection with the various embodiments of the respective aspects of the invention, the invention is widely applicable to all other types of recording media cartridges that are intended to accommodate magnetic disks, magneto-optical disks and other recording media of different formats than magnetic tape.

The applicability of the joint structure of the invention is by no means limited to the magnetic tape cartridge taken as a representative example and it can be widely used as a substitute joint structure for various parts and members of products (e.g. personal computers and portable mini-disk playback apparatus) that have heretofore been fastened with screws.

The multi-color molding technology described in connection with the eleventh aspect of the invention is not only applicable to the molding of components of recording media cartridges, it is also applicable to a wide range of plastic members adapted for easy disassembly (so-called of an easy-to-disassemble type). Given the choice of appropriate materials, the multi-color molding technology of the invention can be applied to the manufacture of a variety of shaped members.

As described above in detail, there is obtained a significant advantage in the first to ninth aspects of the invention and that is the production of recording media cartridges that have no need to use the screws conventionally employed to join an upper case and a lower case in a face-to-face relationship and which therefore exert a smaller impact on the environment.

More specifically, according to the first, second, third, fifth, seventh and eighth aspects of the invention, there can be produced recording media cartridges that do not use any screws to join the upper and lower halves and which yet can be assembled and disassembled with no lower efficiency or with greater ease than when screws are used as fasteners while providing comparable levels of strength and shape stability to the case of using screws as fasteners and the basic performance of which is by no means adversely affected by the change in the method of joining the two halves.

More specifically, according to the fourth and ninth aspects of the invention, the upper case and the lower case can conveniently be joined without using any metallic members such as screws and still the joint is tight enough to make a rugged case body; in addition, the case body can be easily disassembled into the upper case and the lower case and the resin materials with which the constituent parts of the case body are built can be easily assorted for collection and recycling, thus proving effective in reducing the volume of resin wastes. The invention is particularly suitable for use with magnetic tape cartridges of a type in which a tape reel or tape reels around which magnetic tape is wound are accommodated in a case body consisting of an upper half and a lower half.

More specifically, according to the fifth aspect of the invention, there can be produced a recording media cartridge which, in addition to the advantages described above, is adapted to be such that the fact of it having been disassembled is recorded in an unerasable (irreparable) form in order to discourage or prevent the user from disassembling it either accidentally or by wrongful intent.

More specifically, according to the sixth aspect of the invention, there is provided a recording media cartridge that can be easily disassembled into constituent parts, that permits easy separation of synthetic resins from metals, that can be easily reused and which therefore prove effective in recycling the constituent members of the cartridge. Further advantages of the recording media cartridge according to the sixth aspect of the invention are that it can be discarded in a smaller number of parts, that in the manufacturing process can be easily broken down to permit the recycling of the disassembled parts, that the necessary parts can be assembled easily, that the parts, in particular, the upper case and the lower case can be molded as an integral unit using only synthetic resins rather than composites of synthetic resins and metals, and that the parts can be assorted easily.

Further according to the sixth aspect of the invention, the upper engaging portion can be fitted temporarily on the lower engaging portion and this offers the advantage that if required during certain operations in the production process such as mounting, dismounting and fitting-in of components, the upper case can be easily separated from the lower case to improve operation efficiency. As a further advantage, the upper case as fitted temporarily on the lower case is not liable to separate from the latter, providing a sufficiently rugged structure that the efficiency in handling of the magnetic tape cassette on the production line is improved.

As described above in detail, according to the tenth aspect of the invention, there is provided a recording media cartridge that permits easy assortment of the constituent resin materials of the parts or members of the cartridge and which is effective in promoting assorted discarding of the resins. A further advantage of the recording media cartridge according to the tenth aspect of the invention is that on account of easy assortment of constituent resin materials, recyclable resin materials can be assorted for second use, eventually contributing to reducing the volume of resin wastes.

As described above in detail, according to the eleventh aspect of the invention, components for a shaped resin article are molded of mutually compatible materials and one component is caused to adhere to another only in a part; as a result, the capabilities of the shaped resin article are not impaired but the peel strength for the individual components is made small enough to permit easy separation of one component from another, whereby the respective parts of the shaped resin article can be easily separated for collection and the number of parts that can be collected in separate form is increased.

Further according to the eleventh aspect of the invention, a resin product consisting of easily separable members of dissimilar materials can be shaped by multicolor molding using mutually compatible and adhesive materials such that one member adheres to another only in part. The multi-color molding technology used is not only applicable to the molding of components for recording media cartridges, it is also applicable to the molding of a wide range of easy-to-disassemble plastic members.

What is claimed is:

1. A recording media cartridge having a recording medium accommodated in a case body formed by joining an upper case and a lower case in a face-to-face relationship, wherein:
said upper case and said lower case are joined by means of an engaging member fitted between fitting portions provided on opposed inner surfaces of both cases, respectively.

2. The recording media cartridge according to claim 1, wherein said engaging member is a spring pin.

3. The recording media cartridge according to claim 1, wherein:
said fitting portions provided on said upper case and said lower case are either a pair of fitting holes provided within bosses erected on the opposed inner surfaces of said upper case and said lower case respectively, or a fitting hole provided on one of the opposed inner surfaces of said upper case and said lower case and a projection provided on other inner surface; and
said engaging member is fitted between said pair of fitting holes provided on the opposed surfaces of said upper case and said lower case or between the fitting hole provided on said one inner surface and the projection provided on said other inner surface.

4. The recording media cartridge according to claim 3, wherein at least one of said fitting holes in pair or either the fitting hole provided on said one inner surface or the projection provided on said other inner surface or both said fitting hole and said projection are provided with a disengagement hole into which a disengaging tool is inserted in order to cancel a state of fitting.

5. A recording media cartridge having a recording medium accommodated in a case body formed by joining an upper case and a lower case in a face-to-face relationship, wherein:
said upper case and said lower case are joined by means of an engaging member fitted between recesses provided in the outer surfaces of both cases, respectively.

6. The recording media cartridge according to claim 5, wherein said engaging member is a U-shaped engaging member having in both its end portions functional engaging portions that fit into said recesses of said upper case and said lower case to engage therewith.

7. The recording media cartridge according to claim 5, wherein said engaging member is such that functional engaging portions, that fit into said recesses of said upper case and said lower case to engage therewith, are provided on an upper case side and a lower case side, respectively, and is in a form of hollow triangular prism for fitting on a corner portion of said case body.

8. The recording media cartridge according to claim 5, wherein said engaging member is such that its functional engaging portions, that fit into said recesses of said upper case and said lower case to engage therewith, are processed on engaging surfaces facing said case body to have a greater frictional resistance with respect to contact surfaces of said upper case and said lower case.

9. A recording media cartridge having a recording medium accommodated in a case body formed by joining an upper case and a lower case in a face-to-face relationship, wherein:
said upper case and said lower case are joined by means of an engaging member fitted between sidewall surfaces of both cases.

10. The recording media cartridge according to claim 9, wherein said engaging member is an engaging plate or a spring pin.

11. The recording media cartridge according to claim 9, wherein said engaging member is processed to have a greater frictional resistance with respect to contact surfaces of said upper case and said lower case.

12. The recording media cartridge according to claim 9, wherein a disengagement hole into which a disengaging tool is inserted to cancel a state of fitting is provided in a position where said engaging member is fitted.

13. A recording media cartridge having a medium holder for holding a recording medium accommodated in a case body formed by joining an upper case and a lower case in a face-to-face relationship, wherein:
an engaging member, which has an upper engaging end at an upper end and a lower engaging end on a lateral side of a lower end, is provided between said upper case and said lower case along an inner surface of a sidewall of said case body, said upper engaging end being brought into engagement with an engaging portion provided on a top plate of said upper case and said lower engaging end being brought into engagement with an engaging portion provided on a sidewall of said lower case, whereby said upper case and said lower case are joined to make said case body.

14. The recording media cartridge according to claim 13, wherein said engaging member does not interfere with rotation of said medium holder and is located in opposed positions in at least two areas of said upper case and said lower case.

15. A recording media cartridge having a recording medium accommodated in a case body formed by joining an upper case and a lower case in a face-to-face relationship, wherein:
said upper case and said lower case are adapted to be such that they are joined by means of an engaging hole that is provided in at least one of said cases and into which an engaging member is fitted from other case, and said engaging hole is provided with a member that covers a disengaging portion but which can be broken to initiate a disengaging action.

16. The recording media cartridge according to claim 15, wherein a coupling strut is used as a mechanism which establishes engagement with said engaging hole, that is provided on a case opposite that having said engaging hole and which has a split bulging portion at its tip.

17. The recording media cartridge according to claim 15, wherein a spring pin is used as a mechanism which establishes engagement with said engaging hole, that is fitted between engaging holes provided in said upper case and said lower case.

18. The recording media cartridge according to claim 15, wherein a plate-shaped engaging member is used as a mechanism which establishes engagement with said engaging hole, that is inserted into a slit-like portion provided between said upper case and said lower case.

19. A recording media cartridge having a recording medium accommodated in a case body formed by joining an upper case and a lower case in a face-to-face relationship, wherein:
said lower case has a lower engaging portion formed on an upper edge side thereof and said upper case has an upper engaging portion provided on a lower edge side thereof correspondingly to the lower engaging portion and said lower engaging portion is brought into engagement with said upper engaging portion, whereby said lower case is joined integrally with said upper case to make the case body.

20. The recording media cartridge according to claim 19, wherein said lower engaging portion and said upper engaging portion are provided in at least four areas of said upper edge side of said lower case and said lower edge side of said upper case.

21. A recording media cartridge having a magnetic tape on reels accommodated in a case body formed by joining an upper case and a lower case in a face-to-face relationship with the aid of a pawl and an engaging member that corresponds to the pawl, wherein:
said pawl and said engaging member that corresponds to said pawl are provided on said upper case and said lower case at least in a position near a tape guide portion and in positions including said position, that are near four corners of said case body.

22. The recording media cartridge according to claim 21, which is of a two-reel type and has said pawl and said engaging member that corresponds to said pawl, that are to be provided near said tape guide portion, in two positions near said tape guide portion.

23. The recording media cartridge according to claim 22, wherein said pawl and said engaging member that corresponds to said pawl are built into said tape guide portion.

24. The recording media cartridge according to claim 21, which is of a one-reel type and has said pawl and said engaging member that corresponds to said pawl, that are to be provided near said tape guide portion, at least in one position near said tape guide portion and in a position generally symmetric with said position as well.

25. A recording media cartridge having a recording medium accommodated in a case body formed by joining an upper case and a lower case in a face-to-face relationship, wherein:
said upper case and said lower case are adapted to be joined by means of an engaging member provided on either said upper case or said lower case and an engaging portion having a cutout provided on either said lower case or said upper case.

26. The recording media cartridge according to claim 25, wherein said cutout provided on either said lower case or said upper case is in a sidewall portion of either said lower case or said upper case which is to be contacted by a tip portion of said engaging member provided on either said upper case or said lower case.

27. A recording media cartridge having a recording medium accommodated in a case body formed by joining an upper case and a lower case in a face-to-face relationship, wherein:
a fitting groove portion is formed between a guide arm portion, which projects from one sidewall of said upper case to extend parallel to another sidewall of said upper case crossing said one sidewall at right angles, and said another sidewall, said recording media cartridge having a linear guide ridge formed on a lateral surface of said guide arm portion which faces said fitting groove portion, a linear introduction groove cut in an inner surface of said one sidewall of said upper case within an area of said fitting groove portion to extend from a lower case side toward an upper case side, and a disengagement groove cut to extend from said linear introduction groove toward said another sidewall of said upper case via a continuous upwardly arched engagement groove, said recording media cartridge also having a sliding member that is slidably fitted in said fitting groove portion and a fit insertion member that is erected on a bottom of said lower case and which is slidably fit inserted into said fitting groove portion, said sliding member having a slide groove into which said linear guide ridge is fitted, an engaging portion provided on an inner bottom surface of said slide groove that engages an engaging pawl end provided on said linear guide ridge at its end closer to said lower case, and a meshing pawl portion that meshes with a meshing recess provided in said fit insertion member, said recording media cartridge having a guide pin that fits loosely into a linear loose insertion groove cut through a body of said sliding member, with a head at one end of said guide pin being slidably fitted in said linear introduction groove, said linear engagement groove and said disengagement groove and a head at other end projecting from a surface of the sliding member, and a disengagement hole that extends through said another sidewall of said upper case to communicate with an end of said disengagement groove.

28. The recording media cartridge according to claim 27, wherein said upper and lower cases have said joint structure on their sidewalls in at least two opposed areas of the case body.

29. A recording media cartridge having a recording medium accommodated in a case body formed by joining an upper case and a lower case in a face-to-face relationship, wherein:
the constituent parts of said recording media cartridge are colored differently according to the resin materials of which they are made so that the constituent materials of the respective parts can be differentiated and assorted as said recording media cartridge is disassembled.

30. A shaped resin article adapted to be easily separable into members of different constituent materials, wherein:
the respective members are shaped by multi-color molding of mutually compatible and adhesive materials and are allowed to adhere to one another only in part.
